(19) United States
(12) Patent Application Publication
(10) Pub. No.: US 2014/0227325 A1
(43) Pub. Date: Aug. 14, 2014

(54) LIGNIN-DERIVED POROUS CARBON COMPOSITION, METHODS OF PREPARATION, AND USE THEREOF

(71) Applicant: UT-BATTELLE, LLC, Oak Ridge, TN (US)

(72) Inventors: Amit K. Naskar, Knoxville, TN (US); Dipendu Saha, Oak Ridge, TN (US)

(73) Assignee: UT-BATTELLE, LLC, Oak Ridge, TN (US)

(21) Appl. No.: 13/766,292

(22) Filed: Feb. 13, 2013

(51) Int. Cl. B01J 20/30; B01J 20/20

(52) U.S. Cl. CPC B01J 20/3078; B01J 20/20
USPC 424/400; 502/418

(57) ABSTRACT

A method of fabricating a porous carbon composition, the method comprising subjecting a precursor composition to a thermal annealing step followed by a carbonization step, the precursor composition comprising: (i) a templating component comprised of a block copolymer and (ii) a lignin component, wherein said carbonization step comprises heating the precursor composition at a carbonizing temperature for sufficient time to convert the precursor composition to a carbon material comprising a carbon structure in which is included mesopores having a diameter within a range of 2 to 50 nm, wherein said porous carbon composition possesses a mesopore volume of at least 50% with respect to a total of mesopore and micropore volumes. Also described are the resulting mesoporous carbon composition, a composite of the mesoporous carbon material and at least one pharmaceutical agent, and the administration of the carbon-pharmaceutical dosage form to a subject.

This invention was made with government support under Prime Contract No. DE-AC05-00OR22725 awarded by the U.S. Department of Energy. The government has certain rights in the invention.

### FIELD OF THE INVENTION

The present invention relates to the field of porous carbon materials, and more particularly, to such carbon materials containing a mesoporous, bimodal, or hierarchical porosity.

### BACKGROUND OF THE INVENTION

Lignin, a valuable component found in woody or fibrous biomass, is produced on a large scale as a byproduct in the pulping industry and biorefineries worldwide. Significant commercial potential exists in the conversion of lignin to high-value end products (i.e., functional materials), but lignin remains a highly difficult and challenging material to convert into such useful products. Lignin is widely used as a low-value fuel, dispersing agent for chemicals or functional additives, modifier for phenolic resins and adhesives, and as a precursor for activated carbon.

Of particular relevance is the production of porous carbon from lignin. Porous carbon produced from lignin is generally pronounced in microporosity (pores with <2 nm sizes) and/or in macroporosity (pores with >50 nm sizes), and substantially absent in mesoporosity. Although porous carbon compositions having substantial mesoporosity have been developed by carbonization of small phenolic molecules (e.g., phenol and resorcinol), such mesoporosity is generally not found in carbon produced from lignin.

Mesoporous carbon, derived from sources other than lignin, is well known. Since its discovery, mesoporous carbon has attracted significant interest because of its wide range of applications, including as supercapacitors, catalyst supports, fuel cells, membranes, chemical sensors, drug delivery and sorbents. The lack of mesoporosity in existing lignin-derived carbon, as well as the general inability to adjust the pore size in existing methods, are significant obstacles in the use of lignin-derived carbon.

By the “hard template” method, mesoporous carbon is generally synthesized by doping a sacrificial silica scaffold with a carbon precursor followed by carbonization of the precursor and subsequent removal of the silica scaffold (e.g., Ryoo, R., et al., J. Phys. Chem. B, 103, 7743-7746 (1999). By the “soft template” method, mesoporous carbon is generally synthesized by crosslinking a small phenolic compound in the presence of a crosslinking agent (typically, an aldehyde, such as formaldehyde) and a sacrificial non-ionic surfactant, typically an amphiphilic block copolymer that does not have a char yield, followed by pyrolysis, which leads to the volatilization of the surfactant and carbonization of the crosslinked phenolic resin in the same step (e.g., U.S. Pat. No. 8,114,510). The key role of the surfactant is to provide an ordered structural arrangement of the phenolic precursor, i.e., by phase separation and hydrogen bonding. Crosslinking between the precursor and crosslinker stabilizes the morphology, which imparts a mesoporous structure into the carbon structure.

Existing methods for synthesizing mesoporous carbon generally focus on producing an ordered porous structure, i.e., ordered pore size and interpore arrangment. The ordered nature of the porous carbon compositions of the art is generally achieved by use of small phenolic compounds of unvarying and typically symmetric molecular structure, such as phenol, resorcinol, or phloroglucinol. In contrast, lignin is a material with wide structural variation in any given sample, and thus, cannot provide a uniform pore structure. Moreover, the very large size of lignin (typically, average molecular weights of 1000-30,000 Da and higher) presents significant challenges for incorporating it into any of the existing methods for producing a mesoporous carbon.

### SUMMARY OF THE INVENTION

In one aspect, the invention is directed to a method for fabricating a mesoporous carbon composition from lignin. The method generally entails subjecting a precursor composition to a thermal annealing step followed by a carbonization step, wherein the precursor composition includes at least: (i) a templating component that includes a block copolymer and (ii) a lignin component. The carbonization step entails heating the precursor composition at a carbonizing temperature for sufficient time to convert the precursor composition to a mesoporous carbon material. In some embodiments, a crosslinking agent (e.g., an aldehyde or aldehyde generator) is excluded from the precursor composition in the method. A three-dimensional, large lignin molecule, either in native or partially degraded state, forms an interpenetrating polyblend with the templating component. The polyblend, when heated slowly without complete melting of the matrix, retains its phase-separated morphology, which yields mesoporous carbon, after pyrolysis. In other embodiments, a crosslinker is included in the precursor composition, in which case the thermal annealing step can function as a curing (crosslinking) step. The precursor composition may also include a pH controlling agent (i.e., acid or base), particularly when a crosslinking agent is included.

In another aspect, the invention is directed to the mesoporous carbon composition produced by the method described above. The mesoporous carbon composition is characterized by having a carbon structure in which is included mesopores having a diameter within a range of 2 to 50 nm, and in which the pore volume attributed to mesopores (i.e., mesopore volume) is at least or greater than 50% with respect to the total of mesopore and micropore volumes. By virtue of the substantial variation in lignin composition, size, and structure, the mesoporous carbon composition produced herein generally possesses a distribution (i.e., range) of pore sizes. In some embodiments, the distribution of pore sizes is characterized by a difference in minimum and maximum mesopore sizes of at least 5, 10, 15, or 20 nm. In certain applications, such as when applied as a pharmaceutical vehicle or scaffold, the presence of a pore size distribution has herein been found to be advantageous, particularly for the retention of two or more pharmaceutical agents of different sizes, wherein pores of larger size can accommodate larger molecules, and pores of smaller size can accommodate smaller molecules.

In another aspect, the invention is directed to a pharmaceutical-containing composition in which at least one or two pharmaceutical compounds are adsorbed in mesopores (and/or micropores or macropores) of the mesoporous carbon composition described above. The pharmaceutical-containing composition is particularly useful as a dosage form, and more particularly, for the controlled and/or targeted release of the adsorbed pharmaceutical when the pharmaceutical-containing composition is administered to a subject.

The mesoporous carbon compositions described herein may have numerous other uses. Other possible applications include, for example, gas separation, chromatography, filtration of macromolecules or chemicals from dispersion or solution (e.g., dye adsorption from a textile waste stream), catalysis (e.g., as a support or active material), electrode materials (e.g., in batteries or capacitive deionization), and supercapacitors. In particular embodiments, the mesoporous carbon considered herein is in the form of particles or a film (i.e., layer).

The method described herein for producing mesoporous carbon materials from lignin represents a significant advance in the use of lignin for producing novel and useful products heretofore not able to be produced from lignin. Utilization of lignin for the synthesis of mesoporous carbon will not only help to reduce the carbon footprint via use of a renewable carbon source, but also provides a significantly less expensive mesoporous carbon compared to current mesoporous carbons produced from fine chemical precursors. The method described herein can also advantageously dispense with the use of toxic crosslinkers, such as formaldehyde.

### BRIEF DESCRIPTION OF THE DRAWINGS

FIGS. 1A, 1B. FIG. 1A shows an adsorption-desorption plot of mesoporous carbons derived from lignin, Pluronic F127 copolymer as templating agent, formaldehyde as crosslinker, and acid catalyst, wherein 1:1 and 1:2 lignin-surfactant ratios were used. FIG. 1B shows a pore size distribution plot (both cumulative and differential pore volumes) of the mesoporous carbons resulting from 1:1 and 1:2 lignin-surfactant ratios.

FIGS. 2A, 2B. FIG. 2A shows an adsorption-desorption plot of mesoporous carbon derived from lignin, Pluronic F127 copolymer as templating agent, formaldehyde as crosslinker, and base catalyst. FIG. 2B shows a pore size distribution plot (both cumulative and differential pore volumes) of the mesoporous carbon.

FIGS. 3A, 3B. FIG. 3A shows an adsorption-desorption plot of mesoporous carbon derived from lignin, Pluronic F127 copolymer as templating agent, HMTA as crosslinker, and acid catalyst. FIG. 3B shows a pore size distribution plot (both cumulative and differential pore volumes) of the mesoporous carbon.

FIGS. 4A, 4B. (Comparative Example) FIG. 4A shows an adsorption-desorption plot of the mesoporous carbon derived from phloroglucinol, Pluronic F127 or L81 copolymer as templating agent, HMTA as crosslinker, and base catalyst. FIG. 4B shows pore size distribution plots (both cumulative and differential pore volumes) of the mesoporous carbons for each of the Pluronic F127 and L81 surfactants.

FIGS. 5A, 5B. FIG. 5A shows an adsorption-desorption plot of mesoporous carbon derived from lignin and Pluronic F127 copolymer as templating agent (no crosslinker) using either DMF or THF as a reaction solvent. FIG. 5B shows pore size distribution plots (both cumulative and differential pore volumes) of the mesoporous carbons for each of the DMF and THF solvents.

FIG. 6. Scheme showing possible mechanism by which surfactant may function as a template to organize lignin macromolecules.

FIGS. 7A, 7B. FIG. 7A is a thermogravimetric analysis (TGA) plot for carbon precursors LC-0, LMC-1, and LMC-2, and for the surfactant Pluronic F127. FIG. 7B shows derivative plots of the TGA plots shown in FIG. 7A.

FIG. 8. Small-angle and wide-angle x-ray scattering (SAXS and WAXS) of mesoporous carbons LMC-1, LMC-2, and LC-0.

FIGS. 9A-9D. Scanning electron microscope (SEM) images of mesoporous carbons LMC-1 (FIG. 9A) and LC-0 (FIG. 9B). Transmission electron microscope (TEM) images of mesoporous carbons LMC-1 (FIG. 9C) and LC-0 (FIG. 9D).

FIGS. 10A-10G. Release profile of Captopril, Furosemide, Ranitidine and Antipyrine from LMC-1, LMC-2 and PMC (phloroglucinol derived mesoporous carbon) in simulated gastric fluid (SGF) and simulated intestinal fluid (SIF). FIG. 10A: Release profile of Captopril from LMC-1 and LMC-2 in SGF; FIG. 10B: Release profile of Captopril from LMC-2 and PMC in SGF; FIG. 10C: Release profile of Furosemide from LMC-2 and PMC in SGF; FIG. 10D: Release profile of Furosemide from PMC in SIF; FIG. 10E: Release profile of Ranitidine from LMC-2 and PMC in SGF; FIG. 10F: Release profile of antipyrine from PMC in SGF; FIG. 10G: Release profile of antipyrine from LMC-2 in SGF.

FIG. 11. Eyring equation plot to calculate activation energy of diffusion of antipyrine.

FIGS. 12A-12D. Cumulative and differential pore size distribution of drug-loaded LMC-2 and PMC. FIG. 12A: Cumulative and differential pore size distribution of Captopril-, Furosemide-, and Ranitidine-loaded (adsorbed) PMC. FIG. 12B: Cumulative and differential pore size distribution of Captopril-, Furosemide-, and Ranitidine-loaded (adsorbed) LMC-2. FIG. 12C: Cumulative and differential pore size distribution of antipyrine-loaded (adsorbed) PMC. FIG. 12D: Cumulative and differential pore size distribution of antipyrine-loaded (adsorbed) LMC-2.

### DETAILED DESCRIPTION OF THE INVENTION

As used herein, the term “about” generally indicates within ±0.5%, 1%, 2%, 5%, or up to ±10% of the indicated value. For example, a molecular weight of about 10,000 g/mol generally indicates, in its broadest sense, 10,000 g/mol±10%, which indicates 9,000-11,000 g/mol.

In one aspect, the invention is directed to a method for fabricating a mesoporous carbon composition from lignin. The method involves subjecting a precursor composition to a thermal annealing step followed by a carbonization step, wherein the precursor composition may have been previously prepared, isolated, and stored for later use, or prepared directly before the thermal annealing and carbonization steps. The precursor composition includes at least: (i) a templating component that includes a block copolymer, and (ii) a lignin component. In some embodiments, the precursor composition contains only the foregoing two components, i.e., any other compound or material not within the scope of the foregoing components is excluded. In some embodiments, a crosslinker (e.g., an aldehyde or aldehyde generator) is included in the precursor composition. In other embodiments, a pH controlling agent (e.g., acid or base) is included in the precursor composition, particularly when a crosslinker is included. In yet other embodiments, a crosslinker and/or pH controlling agent are excluded from the precursor composition.

The lignin component functions as a carbon precursor. In contrast, the templating component (i.e., block copolymer) functions to organize the lignin in an ordered (i.e., patterned) or semi-ordered arrangement before the carbonization step. During carbonization, the block copolymer is typically completely volatized into gaseous byproducts, and thereby, generally does not contribute to the carbon content. However, the volatile gases serve the important role of creating the pores in the carbon structure during the carbonization step.

The templating component includes one or more block copolymers. The block copolymer preferably has the ability to establish selective interactions with the lignin component and any other carbon precursors in such a manner that an organized network of interactions between the block copolymer and lignin component results. Typically, such selective interactions occur when at least two different segments of the block copolymer differ in hydrophobicity (or hydrophilicity). Generally, a block copolymer that can self-organize based on hydrophobic or other variations will be suitable as a templating component herein. Such block copolymers typically form periodic structures by virtue of selective interactions between like domains, i.e., between hydrophobic domains and between hydrophilic domains. In some embodiments, the templating component includes only one or more block copolymers, i.e., excludes other compounds and materials that are not block copolymers. In some embodiments, the block copolymer includes one or more ionic groups. In other embodiments, the block copolymer is non-ionic.

As used herein, a “block copolymer” is a polymer containing two or more chemically distinct polymeric blocks (i.e., sections or segments). The copolymer can be, for example, a diblock copolymer (e.g., A-B), triblock copolymer (e.g., A-B-C), tetrablock copolymer (e.g., A-B-C-D), or higher block copolymer, wherein A, B, C, and D represent chemically distinct polymeric segments. The block copolymer is preferably not completely inorganic, and more preferably, completely organic (i.e., carbon-based) in order that the block copolymer is at least partially capable of volatilizing during the carbonization step. The block copolymer is typically linear; however, branched (e.g., glycerol branching units) and grafted block copolymer variations are also contemplated herein. Preferably, the block copolymer contains polar groups capable of interacting (e.g., by hydrogen or ionic bonding) with at least the lignin component. Some of the groups preferably located in the block copolymer that can provide a favorable interactive bond with phenolic or aliphatic hydroxyl groups of the lignin and/or carbonyl groups of a crosslinker include, for example, ether, hydroxy, amino, imino, and carbonyl groups. For this reason, the block copolymer is preferably not a complete hydrocarbon such as styrene-butadiene, although it may be desirable in some situations to include a generally hydrophobic polymer or block copolymer with a polar interactive block copolymer to suitably modify or enhance the organizing or patterning characteristics and ability of the polar block copolymer. For analogous reasons, a generally hydrophilic polymer (e.g., a polyalkylene oxide, such as polyethylene oxide or polypropylene oxide) or generally hydrophilic block copolymer may be included with the polar interactive block copolymer. In other embodiments, such generally hydrophobic or hydrophilic polymers or copolymers are excluded.

Some examples of classes of block copolymers suitable as templating agents include those containing segments of polyacrylate or polymethacrylate (and esters thereof), polystyrene, polyethyleneoxide, polypropyleneoxide, polyethylene, polyacrylonitrile, polylactide, and polycaprolactone. Some specific examples of templating block copolymers include polystyrene-b-poly(methylmethacrylate) (i.e., PS-PMMA), polystyrene-b-poly(acrylic acid) (i.e., PS-PAA), polystyrene-b-poly(4-vinylpyridine) (i.e., PS-P4VP), polystyrene-b-poly(2-vinylpyridine) (i.e., PS-P2VP), polyethylene-b-poly(4-vinylpyridine) (i.e., PE-P4VP), polystyrene-b-polyethyleneoxide (i.e., PS-PEO), polystyrene-b-poly(4-hydroxystyrene), polyethyleneoxide-b-polypropyleneoxide (i.e., PEO-PPO), polyethyleneoxide-b-poly(4-vinylpyridine) (i.e., PEO-P4VP), polyethylene-b-polyethyleneoxide (i.e., PE-PEO), polystyrene-b-poly(D,L-lactide), polystyrene-b-poly(methylmethacrylate)-b-polyethyleneoxide (i.e., PS-PMMA-PEO), polystyrene-b-polyacrylamide, polystyrene-b-polydimethylacrylamide (i.e., PS-PDMA), polystyrene-b-polyacrylonitrile (i.e., PS-PAN), and polyethyleneoxide-b-polyacrylonitrile (i.e., PEO-PAN). In some embodiments, one or more of any of the foregoing classes or specific types of copolymers are excluded.

In particular embodiments, the block copolymer is a diblock or triblock copolymer containing two or three segments, respectively, which have alkyleneoxide compositions, particularly wherein the alkyleneoxide is selected from polyethyleneoxide (PEO) and polypropyleneoxide (PPO) segments. In more particular embodiments, the block copolymer is an alkyleneoxide triblock copolymer, such as a poloxamer (i.e. Pluronic® or Lutrol® polymer) according to the general formula (PEO)ₐ-(PPO)_{b}-(PEO)_{c}, wherein PEO is a polyethylene oxide block and PPO is a polypropylene block (i.e., —CH₂CH(CH₃)O— or —CH(CH₃)CH₂O—), and the subscripts a, b, and c represent the number of monomer units of PEO and PPO, as indicated. Typically, a, b, and c are each at least 2, and more typically, at least 5, and typically up to a value of 100, 120, or 130. Subscripts a and c are often of equal value in these types of polymers. In different embodiments, a, b, and c can independently have a value of about, or at least, or up to 10, 20, 30, 40, 50, 60, 70, 80, 90, 100, 120, 130, 140, 150, 160, 180, 200, 220, 240, or any particular range established by any two of these exemplary values.

In one embodiment, a and c subscripts are each less than b, i.e., the hydrophilic PEO block is shorter on each end than the hydrophobic PPO block. For example, in different embodiments, a, b, and c can each independently have a value of 2, 5, 7, 10, 12, 15, 20, 25, 30, 35, 40, 45, 50, 55, 60, 65, 70, 75, 80, 85, 90, 95, 100, 110, 120, 130, 140, 150, or 160, or any range delimited by any two of these values, provided that a and c values are each less than b. Furthermore, in different embodiments, it can be preferred for the a and c values to be less than b by a certain number of units, e.g., by 2, 5, 7, 10, 12, 15, 20, 25, 30, 35, 40, 45, or 50 units, or any range therein. Alternatively, it can be preferred for the a and c values to be a certain fraction or percentage of b (or less than or greater than this fraction or percentage), e.g., about 10%, 20%, 25%, 30, 33%, 40%, 50%, 60%, 70%, 75%, 80%, 85%, 90%, or any range delimited by any two of these values.

In another embodiment, a and c subscripts are each greater than b, i.e., the hydrophilic PEO block is longer on each end than the hydrophobic PPO block. For example, in different embodiments, a, b, and c can each independently have a value of 2, 5, 7, 10, 12, 15, 20, 25, 30, 35, 40, 45, 50, 55, 60, 65, 70, 75, 80, 85, 90, 95, 100, 110, 120, 130, 140, 150, or 160, or any range delimited by any two of these values, provided that a and c values are each greater than b. Furthermore, in different embodiments, it can be preferred for the a and c values to be greater than b by a certain number of units, e.g., by 2, 5, 7, 10, 12, 15, 20, 25, 30, 35, 40, 45, or 50 units, or any range therein. Alternatively, it can be preferred for the b value to be a certain fraction or percentage of a and c values (or less than or greater than this fraction or percentage), e.g., about 10%, 20%, 25%, 30, 33%, 40%, 50%, 60%, 70%, 75%, 80%, 85%, 90%, or any range delimited by any two of these values.

In different embodiments, the poloxamer preferably has a minimum average molecular weight of at least 500, 800, 1000, 1200, 1500, 2000, 2500, 3000, 3500, 4000, or 4500 g/mole, and a maximum average molecular weight of 5000, 5500, 6000, 6500, 7000, 7500, 8000, 8500, 9000, 9500, 10,000, 12,000, 15,000, or 20,000 g/mole, wherein a particular range can be established between any two of the foregoing values, and particularly, between any two the minimum and maximum values. The viscosity of the polymers is generally at least 200, 250, 300, 350, 400, 450, 500, 550, 600, or 650 centipoise (cps), and generally up to 700, 800, 900, 1000, 1500, 2000, 2500, 3000, 3500, 4000, 4500, 5000, 5500, 6000, 6500, 7000, or 7500 cps, or any particular range established between any two of the foregoing values.

The following table lists several exemplary poloxamer polymers applicable to the present invention.

TABLE 1
Some exemplary poloxamer polymers

| | | | Approx- | |
|---|---|---|---|---|
| | Pluronic® | Approximate | imate | Approximate |
| Generic Name | Name | value of a | value of b | value of c |
| Poloxamer 101 | Pluronic L-31 | 2 | 16 | 2 |
| Poloxamer 105 | Pluronic L-35 | 11 | 16 | 11 |
| Poloxamer 108 | Pluronic F-38 | 46 | 16 | 46 |
| Poloxamer 122 | — | 5 | 21 | 5 |
| Poloxamer 123 | Pluronic L-43 | 7 | 21 | 7 |
| Poloxamer 124 | Pluronic L-44 | 11 | 21 | 11 |
| Poloxamer 181 | Pluronic L-61 | 3 | 30 | 3 |
| Poloxamer 182 | Pluronic L-62 | 8 | 30 | 8 |
| Poloxamer 183 | — | 10 | 30 | 10 |
| Poloxamer 184 | Pluronic L-64 | 13 | 30 | 13 |
| Poloxamer 185 | Pluronic P-65 | 19 | 30 | 19 |
| Poloxamer 188 | Pluronic F-68 | 75 | 30 | 75 |
| Poloxamer 212 | — | 8 | 35 | 8 |
| Poloxamer 215 | — | 24 | 35 | 24 |
| Poloxamer 217 | Pluronic F-77 | 52 | 35 | 52 |
| Poloxamer 231 | Pluronic L-81 | 6 | 39 | 6 |
| Poloxamer 234 | Pluronic P-84 | 22 | 39 | 22 |
| Poloxamer 235 | Pluronic P-85 | 27 | 39 | 27 |
| Poloxamer 237 | Pluronic F-87 | 62 | 39 | 62 |
| Poloxamer 238 | Pluronic F-88 | 97 | 39 | 97 |
| Poloxamer 282 | Pluronic L-92 | 10 | 47 | 10 |
| Poloxamer 284 | — | 21 | 47 | 21 |
| Poloxamer 288 | Pluronic F-98 | 122 | 47 | 122 |
| Poloxamer 331 | Pluronic L-101 | 7 | 54 | 7 |
| Poloxamer 333 | Pluronic P-103 | 20 | 54 | 20 |
| Poloxamer 334 | Pluronic P-104 | 31 | 54 | 31 |
| Poloxamer 335 | Pluronic P-105 | 38 | 54 | 38 |
| Poloxamer 338 | Pluronic F-108 | 128 | 54 | 128 |
| Poloxamer 401 | Pluronic L-121 | 6 | 67 | 6 |
| Poloxamer 403 | Pluronic P-123 | 21 | 67 | 21 |
| Poloxamer 407 | Pluronic F-127 | 98 | 67 | 98 |

As known in the art, the names of the poloxamers and Pluronics (as given above) contain numbers that provide information on the chemical composition. For example, the generic poloxamer name contains three digits, wherein the first two digits x 100 indicates the approximate molecular weight of the PPO portion and the last digit x 10 indicates the weight percent of the PEO portion. Accordingly, poloxamer 338 possesses a PPO portion of about 3300 g/mole molecular weight, and 80 wt % PEO. In the Pluronic name, the letter indicates the physical form of the product, i.e., L=liquid, P=paste, and F=solid, i.e., flake. The first digit, or two digits for a three-digit number, multiplied by 300, indicates the approximate molecular weight of the PPO portion, while the last digit×10 indicates the weight percent of the PEO portion. For example, Pluronic® F-108 (which corresponds to poloxamer 338) indicates a solid form composed of about 3,000 g/mol of the PPO portion and 80 wt % PEO.

Numerous other types of copolymers containing PEO and PPO blocks are possible, all of which are applicable herein. For example, the block copolymer can also be a reverse poloxamer of general formula (PPO)ₐ-(PEO)_{b}-(PPO)_{c}, wherein all of the details considered above with respect to the regular poloxamers (e.g., description of a, b, and c subscripts, and all of the other exemplary structural possibilities) are applicable by reference herein for the reverse poloxamers.

In another variation, the block copolymer contains a linking diamine group (e.g., ethylenediamine, i.e., EDA) or triamine group (e.g., melamine). Some examples of such copolymers include the Tetronics® (e.g., PEO-PPO-EDA-PPO-PEO) and reverse Tetronics® (e.g., PPO-PEO-EDA-PEO-PPO).

The lignin component can be any of a wide variety of lignin compositions found in nature or as known in the art. As known in the art, there is no uniform lignin composition found in nature. Lignin is a random polymer that shows significant compositional variation between plant species. Many other conditions, such as environmental conditions, age, and method of processing, influence the lignin composition. Lignins differ mainly in the ratio of three primary monomeric constituent alcohol units, i.e., p-coumaryl alcohol, guaiacyl alcohol or coniferyl alcohol, sinapyl alcohol or syringyl alcohol, and their derivatives such as 5-hydroxy coniferyl alcohol, dihydroconiferyl alcohol, ferulic acid, caffeic acid, caffeyl alcohol, coniferaldehyde, etc. The polymerization of p-coumaryl alcohol, coniferyl alcohol, and sinapyl alcohol forms the p-hydroxyphenyl (H), guaiacyl (G) and syringyl (S) components of the lignin polymer, respectively. The precursor lignin can have any of a wide variety of relative weight percents (wt %) of H, G, and S components. For example, the precursor lignin may contain, independently for each component, at least, up to, or less than 1 wt %, 2 wt %, 5 wt %, 10 wt %, 20 wt %, 30 wt %, 40 wt %, 50 wt %, 60 wt %, 70 wt %, 80 wt %, or 90 wt %, or a range thereof, of any of the H, G, and S components. Typically, the sum of the wt % of each H, G, and S component is 100%, or at least 98% if other minor components are considered. Different wood and plant sources (e.g., hardwood, softwood, switchgrass, and bagasse) often widely differ in their lignin compositions.

Besides the natural variation of lignins, there can be further compositional variation based on the manner in which the lignin has been processed. For example, the precursor lignin can be a Kraft lignin, sulfite lignin (i.e., lignosulfonate), or a sulfur-free lignin. As known in the art, a Kraft lignin refers to lignin that results from the Kraft process. In the Kraft process, a combination of sodium hydroxide and sodium sulfide (known as “white liquor”) is reacted with lignin to form a dark-colored lignin bearing thiol groups. Kraft lignins are generally water- and solvent-insoluble materials with a high concentration of phenolic groups. They can typically be made soluble in aqueous alkaline solution. As also known in the art, sulfite lignin refers to lignin that results from the sulfite process. In the sulfite process, sulfite or bisulfate (depending on pH), along with a counterion, is reacted with lignin to form a lignin bearing sulfonate (SO₃H) groups. The sulfonate groups impart a substantial degree of water-solubility to the sulfite lignin. There are several types of sulfur-free lignins known in the art, including lignin obtained from biomass conversion technologies (such as those used in ethanol production), solvent pulping (i.e., the “organosolv” process), and soda pulping. In particular, organosolv lignins are obtained by solvent extraction from a lignocellulosic source, such as chipped wood, followed by precipitation. Due to the significantly milder conditions employed in producing organosolv lignins (i.e., in contrast to Kraft and sulfite processes), organosolv lignins are generally more pure, less degraded, and generally possess a narrower molecular weight distribution than Kraft and sulfite lignins. Any one or more of the foregoing types of lignins may be used (or excluded) as a precursor lignin in the method described herein for producing a crosslinked lignin.

The lignin component is preferably substantially soluble in a polar organic solvent or aqueous alkaline solution. As used herein, the term “substantially soluble” generally indicates that at least 1, 2, 5, 10, 20, 30, 40, or 50 grams of the crosslinked lignin completely dissolves or homogenizes in 1 deciliter (100 mL) of the polar organic solvent or aqueous alkaline solution. In other embodiments, the solubility is expressed as a wt % of the lignin in solution. In particular embodiments, the lignin has sufficient solubility to produce at least a 5 wt %, 10 wt %, 15 wt %, 20 wt %, 30 wt %, 40 wt %, or 50 wt % solution in the polar organic solvent or aqueous alkaline solution. The polar organic solvent can be aprotic or protic. Some examples of polar aprotic solvents include the organoethers (e.g., diethyl ether, tetrahydrofuran, and dioxane), nitriles (e.g., acetonitrile, propionitrile), sulfoxides (e.g., dimethylsulfoxide), amides (e.g., dimethylformamide, N,N-dimethylacetamide), organochlorides (e.g., methylene chloride, chloroform, 1,1,-trichloroethane), ketones (e.g., acetone, 2-butanone), and dialkylcarbonates (e.g., ethylene carbonate, dimethylcarbonate, diethylcarbonate). Some examples of polar organic protic solvents include the alcohols (e.g., methanol, ethanol, isopropanol, n-butanol, t-butanol, the pentanols, hexanols, octanols, or the like), diols (e.g., ethylene glycol, diethylene glycol, triethylene glycol), and protic amines (e.g., ethylenediamine, ethanolamine, diethanolamine, and triethanolamine). The aqueous alkaline solution can be any aqueous-containing solution having a pH of at least (or over) 8, 9, 10, 11, 12, or 13. The alkalizing solute can be, for example, an alkali hydroxide (e.g., NaOH or KOH), ammonia, or ammonium hydroxide. Combinations of any of these solvents may also be used. In some embodiments, one or more classes or specific types of solvents are excluded.

The lignin may also be an engineered form of lignin having a specific or optimized ratio of H, G, and S components. Lignin can be engineered by, for example, transgenic and recombinant DNA methods known in the art that cause a variation in the chemical structure in lignin and overall lignin content in biomass (e.g., F. Chen, et al., Nature Biotechnology, 25(7), pp. 759-761 (2007) and A. M. Anterola, et al., Phytochemistry, 61, pp. 221-294 (2002)). The engineering of lignin is particularly directed to altering the ratio of G and S components of lignin (D. Guo, et al., The Plant Cell, 13, pp. 73-88, (January 2001). In particular, wood pulping kinetic studies show that an increase in S/G ratio significantly enhances the rate of lignin removal (L. Li, et al., Proceedings of The National Academy of Sciences of The United States of America, 100 (8), pp. 4939-4944 (2003)). The S units become covalently connected with two lignol monomers; on the other hand, G units can connect to three other units. Thus, an increased G content (decreasing S/G ratio) generally produces a highly branched lignin structure with more C—C bonding. In contrast, increased S content generally results in more β-aryl ether (β-O-4) linkages, which easily cleave (as compared to C—C bond) during chemical delignification, e.g., as in the Kraft pulping process. It has been shown that decreasing lignin content and altering the S/G ratio improve bioconvertability and delignification. Thus, less harsh and damaging conditions can be used for delignification (i.e., as compared to current practice using strong acid or base), which would provide a more improved lignin better suited for higher value-added applications, including carbon fiber production and pyrolytic or catalytic production of aromatic hydrocarbon feedstock.

Lab-scale biomass fermentations that leave a high lignin content residue have been investigated (S. D. Brown, et al., Applied Biochemistry and Biotechnology, 137, pp. 663-674 (2007)). These residues will contain lignin with varied molecular structure depending on the biomass source (e.g., wood species, grass, and straw). Production of value-added products from these high quality lignins would greatly improve the overall operating costs of a biorefinery. Various chemical routes have been proposed to obtain value-added products from lignin (J. E. Holladay, et al., Top Value-Added Chemicals from Biomass: Volume II—Results of Screening for Potential Candidates from Biorefinery Lignin, DOE Report, PNNL-16983 (October 2007)).

In some embodiments, an additional phenolic species (e.g., phenol, resorcinol, or the like) is excluded from the precursor composition, thereby making the lignin component the only phenolic material in the precursor composition. In other embodiments, one or more additional phenolic species may be included, along with the lignin component, in the precursor composition.

The additional phenolic species can be any phenolic compound that can react by a condensation reaction with a carbonyl-containing compound (and more particularly, an aldehyde, as described herein) under acidic or basic conditions. Typically, any compound that includes at least one hydroxy group bound to an aromatic ring (typically, a phenyl ring) is suitable for the present invention as a an additional phenolic species.

In one embodiment, the additional phenolic species contains one phenolic hydroxy group (i.e., one hydroxy group bound to a six-membered aromatic ring). Some examples of such compounds include phenol, the halophenols, the aminophenols, the hydrocarbyl-substituted phenols (wherein “hydrocarbyl” includes, e.g., straight-chained, branched, or cyclic alkyl, alkenyl, or alkynyl groups typically containing from 1 to 6 carbon atoms, optionally substituted with one or more oxygen or nitrogen atoms), lignan (enterodiol), hydrocarbyl-unsubstituted phenols, naphthols (e.g., 1- or 2-naphthol), nitrophenols, hydroxyanisoles, hydroxybenzoic acids, fatty acid ester-substituted or polyalkyleneoxy-substituted phenols (e.g., on the 2 or 4 positions with respect to the hydroxy group), phenols containing an azo linkage (e.g., p-hydroxyazobenzene), and phenolsulfonic acids (e.g., p-phenolsulfonic acid). Some general subclasses of halophenols include the fluorophenols, chlorophenols, bromophenols, and iodophenols, and their further sub-classification as, for example, p-halophenols (e.g., 4-fluorophenol, 4-chlorophenol, 4-bromophenol, and 4-iodophenol), m-halophenols (e.g., 3-fluorophenol, 3-chlorophenol, 3-bromophenol, and 3-iodophenol), o-halophenols (e.g., 2-fluorophenol, 2-chlorophenol, 2-bromophenol, and 2-iodophenol), dihalophenols (e.g., 3,5-dichlorophenol and 3,5-dibromophenol), and trihalophenols (e.g., 3,4,5-trichlorophenol, 3,4,5-tribromophenol, 3,4,5-trifluorophenol, 3,5,6-trichlorophenol, and 2,3,5-tribromophenol). Some examples of aminophenols include 2-, 3-, and 4-aminophenol, and 3,5- and 2,5-diaminophenol. Some examples of nitrophenols include 2-, 3-, and 4-nitrophenol, and 2,5- and 3,5-dinitrophenol. Some examples of hydrocarbyl-substituted phenols include the cresols, i.e., methylphenols or hydroxytoluenes (e.g., o-cresol, m-cresol, p-cresol), the xylenols (e.g., 3,5-, 2,5-, 2,3-, and 3,4-dimethylphenol), the ethylphenols (e.g., 2-, 3-, and 4-ethylphenol, and 3,5- and 2,5-diethylphenol), n-propylphenols (e.g., 4-n-propylphenol), isopropylphenols (e.g., 4-isopropylphenol), butylphenols (e.g., 4-n-butylphenol, 4-isobutylphenol, 4-t-butylphenol, 3,5-di-t-butylphenol, 2,5-di-t-butylphenol), hexylphenols, octyl phenols (e.g., 4-n-octylphenol), nonylphenols (e.g., 4-n-nonylphenol), phenylphenols (e.g., 2-phenylphenol, 3-phenylphenol, and 4-phenylphenol), and hydroxycinnamic acid (p-coumaric acid). Some examples of hydroxyanisoles include 2-methoxyphenol, 3-methoxyphenol, 4-methoxyphenol, 3-t-butyl-4-hydroxyanisole (e.g., BHA), and ferulic acid. Some examples of hydroxybenzoic acids include 2-hydroxybenzoic acid (salicylic acid), 3-hydroxybenzoic acid, 4-hydroxybenzoic acid, and their organic acid esters (e.g., methyl salicylate and ethyl-4-hydroxybenzoate).

In another embodiment, the additional phenolic species contains two phenolic hydroxy groups. Some examples of such compounds include catechol, resorcinol, hydroquinone, the hydrocarbyl-linked bis-phenols (e.g., bis-phenol A, methylenebisphenol, and 4,4′-dihydroxystilbene), 4,4′-biphenol, the halo-substituted diphenols (e.g., 2-haloresorcinols, 3-haloresorcinols, and 4-haloresorcinols, wherein the halo group can be fluoro, chloro, bromo, or iodo), the amino-substituted diphenols (e.g., 2-aminoresorcinol, 3-aminoresorcinol, and 4-aminoresorcinol), the hydrocarbyl-substituted diphenols (e.g., 2,6-dihydroxytoluene, i.e., 2-methylresorcinol; 2,3-, 2,4-, 2,5-, and 3,5-dihydroxytoluene, 1-ethyl-2,6-dihydroxybenzene, caffeic acid, and chlorogenic acid), the nitro-substituted diphenols (e.g., 2- and 4-nitroresorcinol), dihydroxyanisoles (e.g., 3,5-, 2,3-, 2,5-, and 2,6-dihydroxyanisole, and vanillin), dihydroxybenzoic acids (e.g., 3,5-, 2,3-, 2,5-, and 2,6-dihydroxybenzoic acid, and their alkyl esters, and vanillic acid), and phenolphthalein.

In another embodiment, the additional phenolic species contains three phenolic hydroxy groups. Some examples of such compounds include phloroglucinol (1,3,5-trihydroxybenzene), pyrogallol (1,2,3-trihydroxybenzene), 1,2,4-trihydroxybenzene, 5-chloro-1,2,4-trihydroxybenzene, resveratrol (trans-3,5,4′-trihydroxystilbene), the hydrocarbyl-substituted triphenols (e.g., 2,4,6-trihydroxytoluene, i.e., methylphloroglucinol, and 3,4,5-trihydroxytoluene), the halogen-substituted triphenols (e.g., 5-chloro-1,2,4-trihydroxybenzene), the carboxy-substituted triphenols (e.g., 3,4,5-trihydroxybenzoic acid, i.e., gallic acid or quinic acid, and 2,4,6-trihydroxybenzoic acid), the nitro-substituted triphenols (e.g., 2,4,6-trihydroxynitrobenzene), and phenol-formaldehyde resoles or novolak resins containing three phenol hydroxy groups.

In yet another embodiment, the additional phenolic species contains multiple (i.e., greater than three) phenolic hydroxy groups. Some examples of such compounds include tannin (e.g., tannic acid), tannin derivatives (e.g., ellagotannins and gallotannins), phenol-containing polymers (e.g., poly-(4-hydroxystyrene)), phenol-formaldehyde resoles or novolak resins containing at least four phenol groups (e.g., at least 4, 5, or 6 phenol groups), quercetin, ellagic acid, and tetraphenol ethane.

In particular embodiments, the additional phenolic species is monocyclic (i.e., contains a phenyl ring not fused or connected to another ring) and contains two or three phenolic hydroxy groups. Generally, if an additional phenolic species is present, the lignin component is present in an amount of at least 10 wt % with respect to the total weight of all phenolic species (i.e., lignin plus additional phenolic species). In different embodiments, the lignin component is present in an amount of at least, above, or up to 20, 30, 40, 50, 60, 70, 80, 90, or 95 wt % by total weight of all phenolic species. In some embodiments, one, two, or more of any of the classes or specific types of additional phenolic species described above are excluded from the precursor composition.

The lignin component typically has a number-average or weight-average molecular weight of at least 1,000 g/mol. In different embodiments, the lignin component has a molecular weight of about, at least, above, up to, or less than, for example, 1,000 g/mol, 5,000 g/mol, 10,000 g/mol, 15,000 g/mol, 20,000 g/mol, 30,000 g/mol, 40,000 g/mol, 50,000 g/mol, 60,000 g/mol, 70,000 g/mol, 80,000 g/mol, 90,000 g/mol, 100,000 g/mol, 120,000 g/mol, 150,000 g/mol, 180,000 g/mol, or 200,000 g/mol, or a molecular weight within a range bounded by any two of the foregoing exemplary values.

In the method for producing the mesoporous carbon, the templating component is typically in a weight ratio to lignin (T/L) within a range of 10:1 and 1:10. In different embodiments, the T/L ratio is about, at least, above, up to, or less than, for example, 10:1, 5:1, 4:1, 3:1, 2:1, 1:1, 1:2, 1:3, 1:4, 1:5, or 1:10, or a T/L ratio within a range bounded by any two of the foregoing ratios.

In some embodiments, the precursor composition further includes a crosslinking agent. The crosslinking agent can be any compound or material known in the art capable of undergoing a crosslinking reaction with a phenolic species. Typically, the crosslinking agent is a carbonyl-containing compound, such as an aldehyde, ketone, or dione. Some examples of aldehydes include formaldehyde, acetaldehyde, propionaldehyde, and furfural. Some examples of ketones include acetone (2-propanone) and butanone. Some examples of diones include malondialdehyde, succinaldehyde, glutaraldehyde, adipaldehyde, pimelaldehyde, suberaldehyde, sebacaldehyde, terephthaldehyde, glyoxal, methylglyoxal, and 2,3-pentanedione. The crosslinking agent may also be a precursor or generator of an aldehyde. Some examples of aldehyde (and particularly, formaldehyde) precursors or generators include hexamethylenetetramine (HMTA), metaformaldehyde, paraformaldehyde, formalin, and 1,3-dioxetane. In other embodiments, one or more subclasses or specific types of crosslinking compounds are excluded from the precursor composition, or crosslinking species may be altogether excluded from the precursor composition.

In the method for producing the mesoporous carbon, when a crosslinking species is included, the crosslinking species is typically in a mole ratio to lignin phenolic groups (i.e., C/P ratio) of at least 1:1 and up to 1:200. In different embodiments, the C/P ratio is about, or at least, for example, 1:1, 1:2, 1:3, 1:4, 1:5, 1:10, 1:20, 1:30, 1:40, 1:50, 1:60, 1:70, 1:80, 1:90, 1:100, 1:120, 1:150, or 1:200, or a C/P ratio within a range bounded by any two of the foregoing values. Alternatively, the crosslinker may be included in a weight ratio, with respect to the lignin component, of about, for example, 5:1, 4:1, 3:1, 2:1, 1:1, 1:2, 1:3, 1:4, 1:5, or 1:10, or a weight ratio within a range bounded by any two of the foregoing values.

The precursor composition may or may not also include a pH controlling agent. The pH controlling agent can be, for example, an acid, base, or buffer. The pH controlling agent is generally included when a crosslinking agent is included in order to facilitate or catalyze a crosslinking (curing) reaction. When an acid or base is included, it is generally strong enough to substantially accelerate the reaction between phenolic and crosslinking (e.g., aldehydic) species. The acid can be a weak acid, such as an organic acid, such as acetic acid, propionic acid, or phosphoric acid. Alternatively, the acid can be a strong acid, such as a mineral acid, such as hydrochloric acid, hydrobromic acid, hydroiodic acid, sulfuric acid, or a superacid, such as triflic acid. Some examples of bases include the metal hydroxides (e.g., hydroxides of lithium, sodium, potassium, magnesium, and calcium), metal alkoxides (e.g., lithium methoxide), metal carbonates (e.g., sodium carbonate), ammonia, and organoamines (e.g., methylamine, dimethylamine, ethylamine, triethylamine, diisopropylamine, aniline, and pyridine). The buffer, if included, can be any of the buffers known in the art, such as a citrate, acetate, phosphate, or borate buffering system. In some embodiments, any one or more classes or specific types of pH controlling agents are excluded from the precursor composition. The pH of the precursor composition, as adjusted by the pH controlling agent, can be, for example, 1, 2, 3, 4, 5, 6, 7, 8, 9, 10, 11, or 12, or within a range bounded by any two of the foregoing pH values.

Depending on the type of acid or base and other conditions, the molar concentration of acid or base (per total volume of precursor composition) in the precursor composition can be at least, above, up to, or less than, for example, 0.5 molar (i.e., 0.5 M), 0.6 M, 0.7 M, 0.8 M, 1.0M, 1.2M, 1.5M, 1.8M, 2.0M, 2.5M, 3.0M, 3.5M, 4.0M, 4.5M, 5.0M, or an acid or base concentration within a range bounded by any two of the foregoing values. The molar concentration values given may also be referred to in terms of molar equivalents of H⁺, or pH, wherein the pH for a strong acid generally abides by the formula pH=−log [H⁺], wherein [H⁺] represents the concentration of H⁺ ions.

Aside from any of the above components in the precursor composition, the precursor composition may also include one or a mixture of solvents that dissolve all of the components. The solvent can be, for example, an organic polar protic or aprotic solvent. Some examples of organic polar protic solvents include alcohols, e.g., methanol, ethanol, n-propanol, isopropanol, ethylene glycol, and the like. Some examples of organic polar aprotic solvents include acetonitrile, dimethylformamide, dimethylsulfoxide, methylene chloride, organoethers (e.g., tetrahydrofuran or diethylether), N-methyl-2-pyrrolidone, and the like. The solvent may also be an inorganic solvent. Some examples of inorganic solvents include water, carbon disulfide, supercritical carbon dioxide, and sulfur dioxide. In some embodiments, any of the classes or particular types of solvents described above may be excluded from the precursor composition.

In some embodiments, all of the precursor components, described above, are combined and mixed to form the precursor composition. The precursor composition can then be deposited by any suitable means known in the art to produce a film (i.e., coating) of the precursor composition on a substrate. Some examples of solution deposition processes include spin-coating, brush coating (painting), spraying, and dipping. After being deposited, the precursor film is subsequently thermally annealed and then carbonized.

In other embodiments, a multi-step process is employed in which a portion of the precursor components is first deposited to produce an initial film, and the initial film subsequently reacted with the remaining component(s) of the precursor composition. For example, a multi-step process may be employed wherein the templating component in combination with the lignin and/or additional phenolic species is first deposited by, for example, applying (i.e., coating) said components onto a surface. If desired, the initially produced film can be converted to a solid film by removing solvent therefrom (e.g., by the thermal annealing process). The solid film formed from templating component and lignin can, in some embodiments, be directly carbonized to form the mesoporous carbon composition. In other embodiments, a solid film formed from the templating component, lignin, a crosslinker, and acid or base is carbonized. In other embodiments, a solid film is first formed from the templating component and lignin, and the solid film subsequently reacted with a crosslinking component (e.g., by a liquid or vapor phase reaction) under acidic or basic conditions, under curing conditions, before subjecting the crosslinked carbon precursor material to a carbonization step. The term “precursor composition”, used herein, is meant to include any of the components that will be subjected to the carbonization step, whether the components are all included before the thermal annealing step, or whether one or more of the components are included subsequently after the thermal annealing step but before the carbonization step.

When a crosslinker is included, the thermal annealing step can function as a curing (crosslinking) step, or a separate curing step may be conducted before or after a thermal annealing (solvent removal) step. The curing step includes any of the conditions, as known in the art, which promote polymerization, and preferably, crosslinking, of polymer precursors, and in particular, crosslinking between phenolic and aldehydic or dione components. The curing conditions generally include application of an elevated temperature for a specified period of time. However, other curing conditions and methods are contemplated herein, including radiative (e.g., UV curing) or purely chemical (i.e., without use of an elevated temperature). In particular embodiments, the curing step involves subjecting the polymer precursors or the entire precursor composition to a temperature of precisely, at least, or about, for example, 50, 60, 70, 80, 90, 100, 110, 120, 130, or 140° C. for a time period of, typically, at least 0.5, 1, 2, 5, 10, 12, 15, 18, or 24 hours, and up to 30, 36, 48, 72, 84, or 96 hours, wherein it is understood that higher temperatures generally require shorter time periods. In some embodiments, a curing step is included in the absence of a crosslinker. In the foregoing embodiment, the lignin component may, itself, contain chemical groups capable of undergoing an autonomous crosslinking reaction.

In particular embodiments, it may be preferred to subject the precursor composition to an initial lower temperature thermal annealing or curing step followed by a higher temperature curing step. The initial thermal annealing or curing step may employ a temperature of about, for example, 50, 60, 70, 80, 90, or 100° C. (or a range between any of these), while the subsequent thermal annealing or curing step may employ a temperature of about, for example, 90, 100, 110, 120, 130, or 140° C. (or a range between any of these), provided that the temperature of the initial heating step is less than the temperature of the subsequent heating step. In addition, each thermal annealing or curing step can independently employ any of the exemplary time periods provided above.

Alternatively, it may be preferred to gradually increase the temperature during the thermal annealing or curing step between any of the temperatures given above, or between room temperature (e.g., 15, 20, 25, 30, or 35° C.) and any of the temperatures given above. In different embodiments, the gradual increase in temperature can be practiced by employing a temperature ramp rate of, or at least, or no more than 1° C./min, 2° C./min, 3° C./min, 5° C./min, 7° C./min, 10° C./min, 12° C./min, 15° C./min, 20° C./min, or 30° C./min, or any suitable range between any of these values. The gradual temperature increase can also include one or more periods of residency at a particular temperature, and/or a change in the rate of temperature increase.

The carbonization step includes any of the conditions, well known in the art, that result in carbonization of the precursor composition. Generally, in different embodiments, a carbonization temperature of precisely, about, or at least, for example, 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1600° C., 1700° C., or 1800° C. (or a range therein) is employed for a time period of, typically, about, at least, above, up to, or less than, for example, 1, 2, 5, 10, 15, 20, or 30 minutes, or 1, 2, 3, 4, 5, 6, 7, 8, 9, 10, 11, or 12 hours, wherein it is understood that higher temperatures generally require shorter time periods to achieve the same result. If desired, the precursor composition, or alternatively, the carbonized material, can be subjected to a temperature high enough to produce a graphitized carbon material. Typically, the temperature capable of causing graphitization is a temperature of or greater than about 2000° C., 2100° C., 2200° C., 2300° C., 2400° C., 2500° C., 2600° C., 2700° C., 2800° C., 2900° C., 3000° C., 3100° C., or 3200° C., or a range between any two of these temperatures. Preferably, the carbonization or graphitization step is conducted in an atmosphere substantially removed of oxygen, e.g., typically under an inert atmosphere. Some examples of inert atmospheres include nitrogen and the noble gases (e.g., helium or argon). Generally, for most purposes of the instant invention, a graphitization step is omitted. Therefore, other conditions that generally favor graphitization (e.g., inclusion of catalytic species, such as iron (III) complexes) are preferably excluded.

In particular embodiments, it may be preferred to subject the precursors to an initial lower temperature carbonization step followed by a higher temperature carbonization step. The initial carbonization step may employ a temperature of about, for example, 100, 200, 300, 350, 400, 450, 500, 550, 600, 650, 700, 750, 800, 850, or 900° C. (or a range between any of these), while the subsequent carbonization step may employ a temperature of about, for example, 400, 450, 500, 550, 600, 650, 700, 750, 800, 850, 900, 950, 1000, 1050, 1100, 1200, 1250, 1300, 1400, 1450, 1500, 1600, 1700, or 1800° C. (or a range between any of these), provided that the temperature of the initial carbonization step is less than the temperature of the subsequent carbonization step. In addition, each carbonization step can employ any of the exemplary time periods given above.

Alternatively, it may be preferred to gradually increase the temperature during the carbonization step between any of the temperatures provided above, or between room temperature (e.g., 15, 20, 25, 30, or 35° C.), or an annealing or curing temperature, and any of the carbonization temperatures provided above. In different embodiments, the gradual increase in temperature can be practiced by employing a temperature increase rate of, or at least, or no more than 1° C./min, 2° C./min, 3° C./min, 5° C./min, 7° C./min, 10° C./min, 12° C./min, 15° C./min, 20° C./min, 30° C./min, 40° C./min, or 50° C./min, or any suitable range between any of these values. The gradual temperature increase can also include one or more periods of residency at a particular temperature, and/or a change in the rate of temperature increase.

In particular embodiments, after combining the components of the precursor composition, and before thermal annealing, curing, or carbonization, the solution is stirred for a period of time to ensure completion of the reaction. The solution can be stirred for a period of time of about, at least, or up to, for example, 1, 2, 5, 10, 20, 30, 40, 50, 60, 90, or 120 minutes, or a time within a range bounded by any of these values. In some embodiments, the precursor solution is stirred until a gel-like phase is formed, which may be evidenced by an increased turbidity in the solution.

In some embodiments, after stirring the precursor solution, the solution may be subjected to a physical process that facilitates separation of a solid or gel-like phase from the solvent. Such physical separation processes are well known in the art. For example, the phases can be separated by centrifugation. In different embodiments, the centrifugation can be conducted at an angular speed of precisely, at least, about, or up to, for example, 2000 rpm, 2500 rpm, 3000 rpm, 4000 rpm, 5000 rpm, 6000 rpm, 7000 rpm, 8000 rpm, 9000 rpm, 9500 rpm, 10000 rpm, 11000 rpm, 12000 rpm, or 15000 rpm, or within a range bounded by any of these values, for a period of time of, for example, 0.1, 0.2, 0.5, 1, 2, 3, 4, 5, or 6 minutes, wherein it is understood that higher angular speeds generally require less amounts of time to effect an equivalent degree of separation. Superspeed centrifugation (e.g., up to 20,000 or 30,000 rpm) or ultracentrifugation (e.g., up to 40,000, 50,000, 60,000, or 70,000 rpm) can also be used. The gel or solid phase, once separated from the liquid phase, is then cured and carbonized in the substantial absence of the liquid phase according to any of the conditions described above for these processes.

The invention is also directed to the mesoporous carbon composition produced by the above-described process. As used herein and as understood in the art, the terms “mesopores” and “mesoporous” refer to pores having a size (i.e., pore diameter or pore size) of at least 2 nm and up to 50 nm, i.e., “between 2 and 50 nm”, or “in the range of 2-50 nm”. In different embodiments, the mesoporous carbon composition contains mesopores having a size of precisely, about, at least, above, up to, or less than, for example, 2 nm, 2.5 nm, 3 nm, 3.5 nm, 4 nm, 4.5 nm, 5 nm, 5.5 nm, 6 nm, 6.5 nm, 7 nm, 7.5 nm, 8 nm, 8.5 nm, 9 nm, 9.5 nm, 10 nm, 11 nm, 12 nm, 15 nm, 20 nm, 25 nm, 30 nm, 35 nm, 40 nm, or 45 nm, and up to or less than 50 nm, or a particular size, or a variation of sizes, within a range bounded by any two of the foregoing values.

The mesoporous carbon composition typically also includes micropores. As used herein, the terms “micropores” and “microporous” refer to pores having a diameter of less than 2 nm. In particular embodiments, the micropores have a size of precisely, about, up to, or less than 0.5, 0.6, 0.7, 0.8, 0.9, 1.0, 1.1, 1.2, 1.3, 1.4, 1.5, 1.6, 1.7, 1.8, or 1.9 nm, or a particular size, or a variation of sizes, within a range bounded by any two of these values.

The mesoporous carbon described herein possesses a pore volume attributed to mesopores (i.e., “mesopore volume”) of at least or greater than 50% by total of mesopore and micropore volumes. In other embodiments, the mesoporous carbon possesses a mesopore volume of at least, above, up to, or less than, for example, 55%, 60%, 65%, 70%, 75%, 80%, 85%, 90%, 95%, 98%, or 99% by total of mesopore and micropore volumes. In other embodiments, the mesoporous carbon material possesses a substantial or complete absence of micropores. By a “substantial absence” of micropores is generally meant that no more than 1%, 0.5%, or 0.1% of the total pore volume, or none of the pore volume, can be attributed to the presence of micropores, i.e., a mesopore volume of 100% by total of mesopore and micropore volumes.

The mesoporous carbon composition may or may not also include macropores. As used herein, the terms “macropores” and “macroporous” refer to pores having a size greater than 50 nm. Generally, the macropores have a size up to or less than 1 micron (1 μm). In different embodiments, the macropores have a size of precisely, about, at least, or greater than 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, 225 nm, 250 nm, 275 nm, 300 nm, 325 nm, 350 nm, 375 nm, 400 nm, 425 nm, 450 nm, 475 nm, 500 nm, 550 nm, 600 nm, 650 nm, 700 nm, 750 nm, 800 nm, 850 nm, 900 nm, 950 nm, or 1000 nm, or a particular size, or a variation (distribution) of pore sizes, within a range bounded by any two of these values.

If macropores are included, in addition to mesopores and micropores, then the mesopore volume by total pore volume is generally at least 10%. In other embodiments, the mesoporous carbon possesses a mesopore volume by total pore volume (which includes mesopores, micropores, and macropores) of about, at least, above, up to, or less than, for example, 15%, 20%, 25%, 30%, 35%, 40%, 45%, 50%, 55%, 60%, 65%, 70%, 75%, 80%, 85%, 90%, 95%, 98%, or 99% by total pore volume. In embodiments where mesopores and macropores are present, but in the substantial or complete absence of micropores, the mesopore volume by total of mesopore and macropore volumes can be any of the exemplary values provided above. In some embodiments, the mesoporous carbon possesses a substantial or complete absence of macropores. By a “substantial absence” of macropores is generally meant that no more than 1%, 0.5%, or 0.1% of the total pore volume, or none of the pore volume, can be attributed to the presence of macropores, i.e., a mesopore volume of 100% by total of mesopore and macropore volumes. In some embodiments, both macropores and micropores are substantially or completely absent, in which case the total pore volume is substantially or completely attributed to the mesopore volume.

Generally, the mesoporous carbon produced herein possesses a distribution of pore sizes. The distribution of pore sizes is characterized by a minimum and maximum pore size. The minimum and maximum pore sizes can be independently selected from any of the mesopore, micropore, and macopore sizes provided above. In different embodiments, the distribution of pore sizes spans only mesopores, or spans micropores and mesopores, or spans mesopores and macropores, or spans micropores, mesopores, and macropores. The difference in minimum and maximum pore size can be at least, for example, 5, 10, 15, 20, 25, 30, 35, 40, 45, 50, 60, 70, 80, 90, 100, 150, 200, 250, 300, 350, 400, 450, or 500 nm.

The mesoporous carbon generally possesses a total pore volume of at least or above 0.1 cm³/g. In other embodiments, the mesoporous carbon may possess a total pore volume of precisely, about, at least, above, up to, or less than, for example, 0.2 cm³/g, 0.25 cm³/g, 0.3 cm³/g, 0.35 cm³/g, 0.4 cm³/g, 0.45 cm³/g, 0.5 cm³/g, 0.55 cm³/g, 0.6 cm³/g, 0.65 cm³/g, 0.7 cm³/g, 0.75 cm³/g, 0.8 cm³/g, 0.9 cm³/g, 1 cm³/g, 1.1 cm³/g, 1.2 cm³/g, 1.3 cm³/g, 1.4 cm³/g, 1.5 cm³/g, 1.6 cm³/g, 1.7 cm³/g, 1.8 cm³/g, 1.9 cm³/g, or 2 cm³/g, or a pore volume within a range bounded by any two of these values. The mesopore volume may also independently be any of the foregoing values.

The pores can have any suitable wall thickness. In particular embodiments, the wall thickness can be precisely, about, at least, above, up to, or less than, for example, 1 nm, 2 nm, 3 nm, 4 nm, 5 nm, 6 nm, 7 nm, 8 nm, 9 nm, 10 nm, 11 nm, 12 nm, 15 nm, 18 nm, 20 nm, 25 nm, 30 nm, 40 nm, 50 nm, 60 nm, 70 nm, 80 nm, 90 nm, 100 nm, 125 nm, 150 nm, 175 nm, 200 nm, 250 nm, 300 nm, 350 nm, 400 nm, 450 nm, or 500 nm, or a wall thickness within a range bounded by any two of these values. The foregoing exemplary wall thicknesses can be for all pores, or for a portion of the pores, e.g., only for mesopores, macropores, or micropores.

The mesoporous carbon typically possesses a surface area (typically, BET surface area) of at least 50 m²/g. In other embodiments, the mesoporous carbon possesses a surface area of precisely, about, at least, above, up to, or less than, for example, 100, 200, 300, 400, 450, 500, 550, 600, 650, 700, 750, 800, 900, 1000, or 1500 m²/g, or a surface area within a range bounded by any two of the foregoing exemplary values.

In some embodiments, at least a portion of the mesoporous carbon material is amorphous rather than graphitic. Generally, an amorphous portion of the carbon material includes micropores, whereas micropores are generally absent from graphitic portions. In different embodiments, precisely, about, or at least 20%, 30%, 40%, 50%, 60%, 70%, 80%, 85%, or 90% of the porous carbon material is amorphous, wherein it is understood that the remaining portion of the carbon material is graphitic or another phase of carbon (e.g., glassy or vitreous carbon). In particular embodiments, the mesoporous carbon material is no more than, or less than, 25%, 20%, 15%, 10%, 5%, 2%, or 1% graphitic. In some embodiments, all (e.g., about or precisely 100%) or substantially all (for example, greater than 90%, 95%, 98%, or 99%) of the porous carbon material is non-graphitic, and may be instead, for example, amorphous or glassy carbon.

The mesoporous carbon material can be in any suitable form, e.g., as rods, cubes, or sheets, depending on the application. In particular embodiments, the porous carbon material is in the form of a film. The film can have any suitable thickness, typically no more than 5 millimeters (5 mm). In different embodiments, the film may have a thickness of precisely, about, up to, at least, or less than, for example, 5 nm, 10 nm, 20 nm, 30 nm, 40 nm, 50 nm, 100 nm, 200 nm, 300 nm, 400 nm, 500 nm, 600 nm, 700 nm, 800 nm, 900 nm, 1.0 μM, 1.2 μm, 1.5 μm, 2.0 μm, 2.5 μm, 3.0 μm, 4.0 μm, 5.0 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, 600 μm, 700 μm, 800 μm, 900 μm, or 1000 μm, or a thickness within a range bounded by any two of these values.

The porous carbon film may also function as part of a composite material, wherein the porous carbon film either overlays, underlies, or is sandwiched between one or more layers of another material. The other material may be porous or non-porous, and can be composed of, for example, a metal, metal alloy, ceramic (e.g., silica, alumina, or a metal oxide), organic or inorganic polymer, or composite or hybrid thereof, depending on the application. In particular embodiments, the porous carbon film functions as a coating on an electrically-conducting substrate suitable as an electrode. In further particular embodiments, the electrically-conducting substrate is, or includes, a carbon material, such as graphite. In other embodiments, the porous carbon film is monolithic (i.e., not disposed on a substrate).

In another embodiment, the mesoporous carbon material is in the form of particles. In different embodiments, the particles can have a size precisely, about, up to, or less than, for example, 5 nm, 10 nm, 20 nm, 30 nm, 40 nm, 50 nm, 100 nm, 200 nm, 500 nm, 1 μm, 2 μm, 5 μm, 10 μm, 50 μm, 100 μm, 500 μm, or 1000 μm, or a size within a range bounded by any two of these values. Particles of the mesoporous carbon material can be produced by any suitable method, such as, for example, by trituration (e.g., grinding), or by a spray atomization technique known in the art. For example, the precursor composition described above (typically, in a carrier solvent, such as THF or DMF) can be sprayed through the nozzle of an atomizer, and the particulates directed into one or more heated chambers for curing and carbonization steps. Alternatively, a portion of the precursor composition (e.g., templating agent and lignin component) may first be atomized and the resulting particles annealed (i.e., dried) by suitable conditions; the resulting particles may then be exposed to a crosslinker and subjected to acidic conditions, followed by curing and carbonization steps.

The mesoporous carbon material may also be functionalized, as desired, by methods known in the art for functionalizing carbon or graphite materials. For example, the mesoporous carbon may be nitrogenated, fluorinated, oxygenated, or silylated by methods known in the art. The mesoporous carbon material may be nitrogenated, fluorinated, oxygenated, or silylated by, for example, exposing it, either during or after the carbonization process, to, respectively, ammonia gas, fluorine gas, an oxygen-containing gas (e.g., ozone or oxygen gas), or a silane or siloxane under suitably reactive conditions. In the particular case of fluorination, the carbon material is typically placed in contact with fluorine gas for a period of several minutes (e.g., 10 minutes) up to several days at a temperature within 20° C. to 500° C., wherein the time and temperature, among other factors, are selected based on the degree of fluorination desired. For example, a reaction time of about 5 hours at ambient temperature (e.g., 15-30° C.) typically results in fluorination of about 10% of the total carbon; in comparison, fluorination conducted at about 500° C. for two days results in about 100% fluorination of the total carbon. In particular embodiments, the degree of nitrogenation, fluorination, or oxygenation can be about or at least 1%, 2%, 5%, 10%, 20%, 30%, 40%, 50%, 60%, 70%, 80%, 90%, 95%, or 100%, or a range between any two of these values. In the case of silylation, the silylating agent can be, for example, a silyl hydride, such as silane, trimethylsilane, dimethylsilane, triethylsilane, t-butyldimethylsilane, and the like, or a chlorosilane, or a siloxane, such as an alkoxysilane (e.g., methoxy-dimethoxy-, or trimethoxy-silane), wherein the carbon substrate may be first functionalized with suitable functional groups for linking the silane or siloxane molecules to the carbon.

The invention is furthermore directed to a pharmaceutical-carbon composite in which at least one, two, or three pharmaceutical compounds are adsorbed in the mesoporous carbon composition described above. In the composite, the mesoporous carbon functions as a non-toxic and structurally robust drug delivery medium. In particular embodiments, the pharmaceutical-carbon composite functions as a controlled release form of the pharmaceutical. Without being bound by theory, it is believed that the pharmaceutical preferentially adsorbs in pores of the mesporous carbon. Moreover, it is believed that the strong adsorption of the pharmaceutical with the carbon is at least partly responsible for the controlled release behavior. In the case of a distribution in pore sizes, the different pore sizes can preferentially adsorb pharmaceutical compounds of similar size, and thus, can be particularly advantageous in adsorbing more than one pharmaceutical compound to be controllably released into a subject after administration. Indeed, a further advantageous aspect of the method described herein is the ability to tune the pore size and distribution, by judicious selection of, for example, type of lignin component, type of templating agent, lignin-templating component ratio, temperature profile in annealing and carbonization steps, and presence or absence of crosslinkers. Thus, the mesoporous carbon structure can be specifically tuned in pore size and distribution to selectively or more strongly adsorb one or more particular pharmaceutical agents.

The pharmaceutical compound adsorbed in the mesoporous carbon can be any pharmaceutical agent or other compound desired to be controllably released. The pharmaceutical agent should have the ability to adsorb onto the carbon. The pharmaceutical compound can function, for example, to treat the gastrointestinal tract, cardiovascular system, central nervous system, or respiratory system, or to treat a disease or condition, such as or related with inflammation, the immune system, cancer, diabetes, allergies, arthritis, or the endocrine system. The pharmaceutical can be, for example, an antibiotic, antiviral agent, antifungal agent, antihypertensive, anti-inflammatory, steroid, antispasmodic, β-receptor blocker, calcium channel blocker, anticancer agent, antiarrhythmic, vasoconstrictor, vasodilator, ACE inhibitor, angiotensin receptor blocker, anticoagulant, statin, antidepressant, selective serotonin reuptake inhibitor (SSRI), anticonvulsant, anxiolytic, antihistamine, serotonin antagonist, NSAID, COX-2 selective inhibitor, muscle relaxant, anticholinesterase, antitussive, mucolytic, decongestant, corticosteroid, insulin, prostaglandin, hormone, or immunosuppressant.

The pharmaceutical-carbon composite can be prepared by placing the mesoporous carbon material and pharmaceutical in contact under conditions where adsorption of the pharmaceutical on the carbon is permitted. For example, the mesoporous carbon and one or more pharmaceutical agents may be mixed in water or an aqueous solution for a suitable period of time until the mesoporous carbon is sufficiently loaded. In some embodiments, a dopant is included to facilitate adsorption or binding of the pharmaceutical agent and carbon. The dopant can be, for example, any of the functionalizing elements described above, or a binding or crosslinking agent.

In another aspect, the invention is directed to methods for the in vivo or in vitro delivery of the above-described pharmaceutical-carbon composite into biological tissue or a living subject. In particular, the invention is directed to a method for treating a subject (patient) by administering to the patient the pharmaceutical-carbon composite described above. The pharmaceutical-carbon composite can be administered by any of the suitable modes of administration known in the art. For example, depending on the disease or condition to be treated, and the type of pharmaceutical, the pharmaceutical-carbon composite may be administered orally, by injection, or by application onto the skin by techniques well known in the medical arts. By loading the mesoporous carbon scaffold with a desired amount of the pharmaceutical, an effective dosage level of the pharmaceutical can be ascertained for administration to the patient.

In other aspects, the mesoporous carbon materials described herein can be used as chromatography media, particularly for use in HPLC, and more particularly, for use in electrochemically modulated liquid chromatography (EMLC), as described, for example, in U.S. Pat. No. 7,449,165, the contents of which are incorporated herein by reference in their entirety.

In other aspects, the mesoporous carbon materials described herein can be further activated, as described, for example, in P J M Carrott and M M L Ribeiro Carrott—Bioresource Technology, Volume 98, Issue 12, September 2007, Pages 2301-231, to obtain enhanced functionality mesoporous-microporous carbon for use in activated carbon-based applications while retaining all of the above mesoporous characteristics.

Examples have been set forth below for the purpose of illustration and to describe certain specific embodiments of the invention. However, the scope of this invention is not to be in any way limited by the examples set forth herein.

### Example 1

### Preparation of Phloroglucinol-Derived Mesoporous Carbon

### Comparative Example

Phloroglucinol and a tri-block copolymer surfactant, Pluronic F127 (BASF) (1:1 w/w), were dissolved in a water-ethanol mixture (4.25:6.0 v/v) and crosslinked with formaldehyde in the presence of 200 μL hydrochloric acid (6 M) as catalyst at ambient (room) temperature (i.e., 18-28° C., or about 22° C.). After two hours of initiating the reaction, the excess water-ethanol mixture was decanted from the top of the reactant mixture and the polymer was cured overnight at 100° C. after which it turned to a red-brown solid matrix. The cured polymer was carbonized in a tube furnace under nitrogen flow by the following temperature profile: room temperature to 400° C. in PC/min, 400° C. to 1000° C. in 2° C./min, maintaining at 1000° C. for 15 minutes, and followed by cooling to near ambient temperature under nitrogen flow.

### Example 2

### Preparation of Lignin-Derived Mesoporous Carbon

Hardwood lignin isolated from black liquor of Kraft processed oak chips was mixed with a tri-block copolymer, Pluronic F127 (1:1 and 1:2 w/w), and dissolved in tetrahydrofuran (THF) in a round bottom flask. The lignin was crosslinked with formaldehyde (37%) in the presence of 600 μL hydrochloric acid (6 M) in 70° C. for 5 days. Note: the septum on the mouth of the flask needed to be sealed very cautiously as the reaction temperature is over the boiling point of THF (66° C.). Due to the highly heterogeneous and macromolecular nature of the lignin, a higher reaction temperature and a significantly longer reaction time were required to crosslink the lignin as compared to crosslinking of homogeneous small phenolics, such as resorcinol and phloroglucinol. After the reaction time, the flask was cooled and the reaction mixture was put on a Petri dish at ambient temperature and then slightly elevated temperature for several hours to slowly evaporate the solvent. All of the dried and cured polymers were carbonized in a tube furnace under nitrogen flow by the following temperature profile: room temperature (RT, ˜22° C.) to 400° C. in 1° C./min, 400° C. to 1000° C. in 2° C./min, maintaining at 1000° C. for 15 minutes, and followed by cooling to near ambient temperature under nitrogen flow. The porosity of the resultant carbon can be tuned by, for example, adjusting the surfactant type, ratio and degree of crosslinking (as also adjusted by selection of reaction temperature and time).

### Example 3

### Formaldehyde-Based Crosslinking of Lignin with Acid Catalyst to Form Mesoporous Carbon

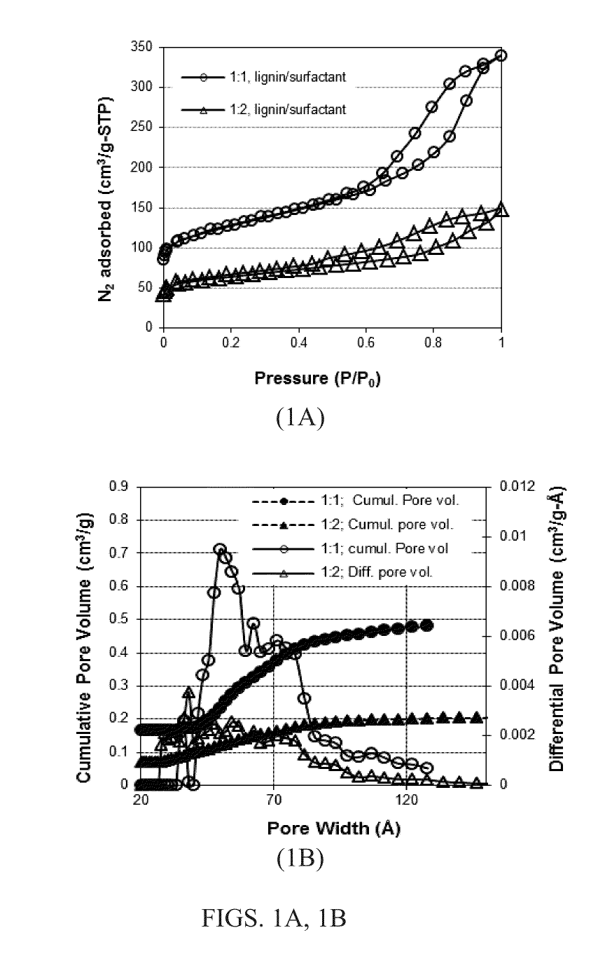

Methanol-soluble Kraft-processed hardwood lignin (5 g) and tri-block copolymer Pluronic F127 (in 1:1 and 1:2 ratio) were dissolved in THF under acidic conditions (200 μL 6M HCl) for several hours. After this, 2 cm³ of 37% formaldehyde solution was added and the mixture stirred for 3 days at 70° C. The reaction mixture was placed on a Petri dish at ambient temperature and then a slightly elevated temperature for several hours to slowly evaporate the solvent. The dried mass was scraped off of the Petri dish and carbonized in a porcelain boat in a tube furnace by the following temperature profile: RT to 100° C. at 10° C./min, 100° C. to 400° C. at 1° C./min, 400° C. to 1000° C. at 2° C./min, and then maintaining the temperature at 1000° C. for 15 minutes. The pore textural characteristics were calculated by analyzing the N₂ adsorption/desorption isotherms at 77 K. FIG. 1A shows an adsorption-desorption plot of the resulting mesoporous carbons resulting from 1:1 and 1:2 lignin-surfactant ratios (LMC-1 and LMC-2, respectively). FIG. 1B shows a pore size distribution plot (both cumulative and differential pore volumes) of the resulting mesoporous carbons resulting from 1:1 and 1:2 lignin-surfactant ratios. The presence of a hysteresis loop for each of the carbons confirms the presence of mesoporosity in these species. The differential pore size distribution plot suggests that pore widths of both LMC-1 and LMC-2 range from 40 to 120 Å, although LMC-2 possesses a lower pore volume than LMC-1.

### Example 4

### Formaldehyde-Based Crosslinking of Lignin with Base Catalyst to Form Mesoporous Carbon

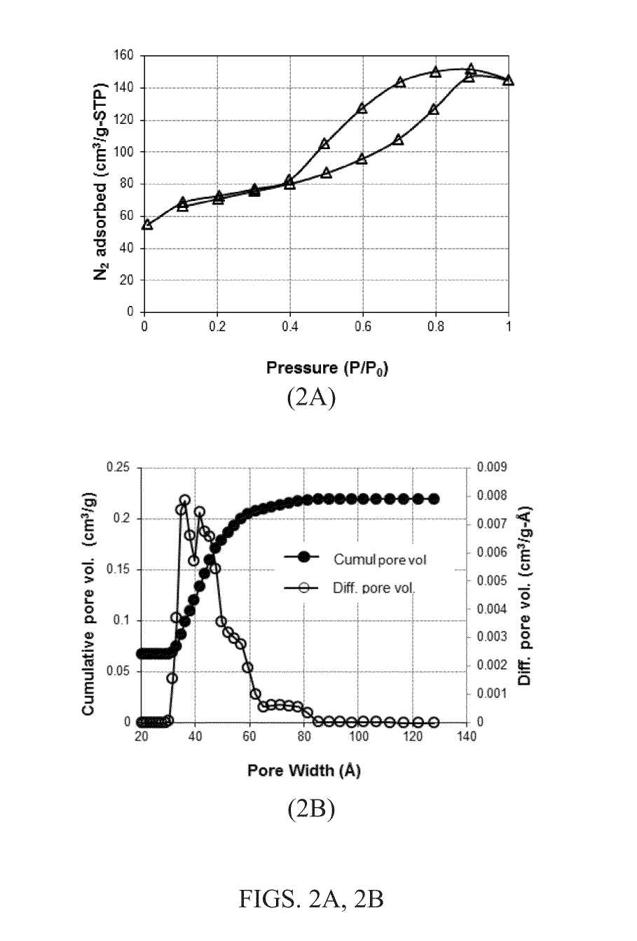

Methanol-soluble Kraft-processed hardwood lignin (1 g) and 0.5 cm³ of 37% formaldehyde were dissolved in a mixture of water and tetrahydrofuran (THF)(1:3 volume ratio) pre-dissolved with 0.06 g of NaOH. The mixture was stirred for three days at 60° C. and the product was dried in a rotovap. Then the dried mass was dissolved in THF containing the tri-block copolymer Pluronic F127 (1:1 ratio) along with 1 cm³ of 6M HCl for 24 hours at room temperature. After that, the solution was placed on a Petri dish and dried in the same manner as in Example 3, and carbonized by the same profile. The resulting mesoporous carbon is designated as LMC-3. FIG. 2A shows an adsorption-desorption plot of LMC-3. FIG. 2B shows a pore size distribution plot (both cumulative and differential pore volumes) of the LMC-3 carbon. The N₂ adsorption-desorption plot is type IV according to IUPAC nomenclature, which confirms the presence of mesoporosity. LMC-3 also exhibited a narrower pore width (30-80 Å) compared to LMC-1 or LMC-2.

### Example 5

### HMTA-Based Crosslinking of Lignin to Form Mesoporous Carbon

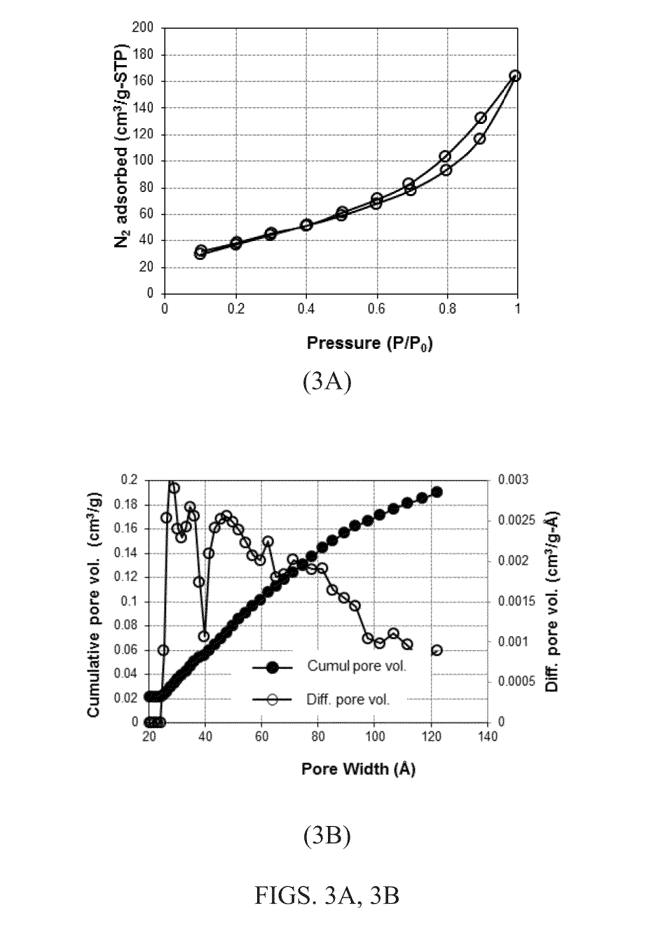

Methanol-soluble Kraft-processed hardwood lignin (1 g) and 0.3 g hexamethylenetetramine (HMTA) were dissolved in a mixture of water and tetrahydrofuran (THF)(1:3 volume ratio) pre-dissolved with 0.06 g of NaOH. The mixture was stirred for three days at 60° C. and the product was dried in a rotovap. Then the dried mass was dissolved in THF containing the tri-block copolymer Pluronic F127 (1:1 ratio) along with 1 cm³ of 6M HCl for 24 hours at room temperature. After that, the solution was placed on a Petri dish and dried in the same manner as in Example 3, and carbonized by the same profile. The resulting mesoporous carbon is designated as LMC-4. FIG. 3A shows an adsorption-desorption plot of the resulting mesoporous carbon (LMC-4). FIG. 3B shows a pore size distribution plot (both cumulative and differential pore volumes) of the resulting mesoporous carbon. The resulting mesoporous carbon exhibits much wider pore width (25 to over 120 Å) compared to other carbons synthesized with the same precursor.

### Example 6

### HMTA-Based Crosslinking of Phloroglucinol to Form Mesoporous Carbon

### Comparative Example

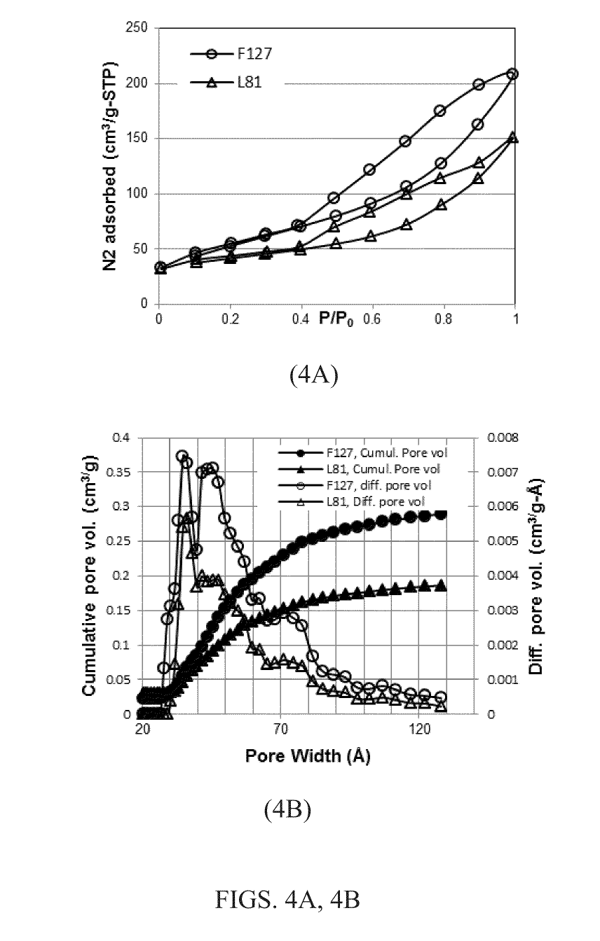

Phloroglucinol was mixed with hexamethylenetetramine (HMTA) (1:0.3 based on phloroglucinol) in an ethanol-water mixture pre-dissolved with 0.06 gm NaOH and stirred at 70° C. for an hour. Then the crosslinked mass was isolated and mixed with either of tri-block copolymer Pluronic F127 or L81 (4.5 g) in 40 cm³ THF and 1 cm³ 6 M HCl under continuous stirring for 24 hours. Finally, the resultant mass was dried with stirring at 60° C. overnight, and carbonized by the temperature profile described in Example 3. FIG. 4A shows an adsorption-desorption plot of the resulting mesoporous carbon for each of the Pluronic F127 and L81 surfactants. FIG. 4B shows pore size distribution plots (both cumulative and differential pore volumes) of the resulting mesoporous carbons for each of the Pluronic F127 and L81 surfactants.

### Example 7

### Lignin-Derived Mesoporous Carbon Formed without Crosslinker

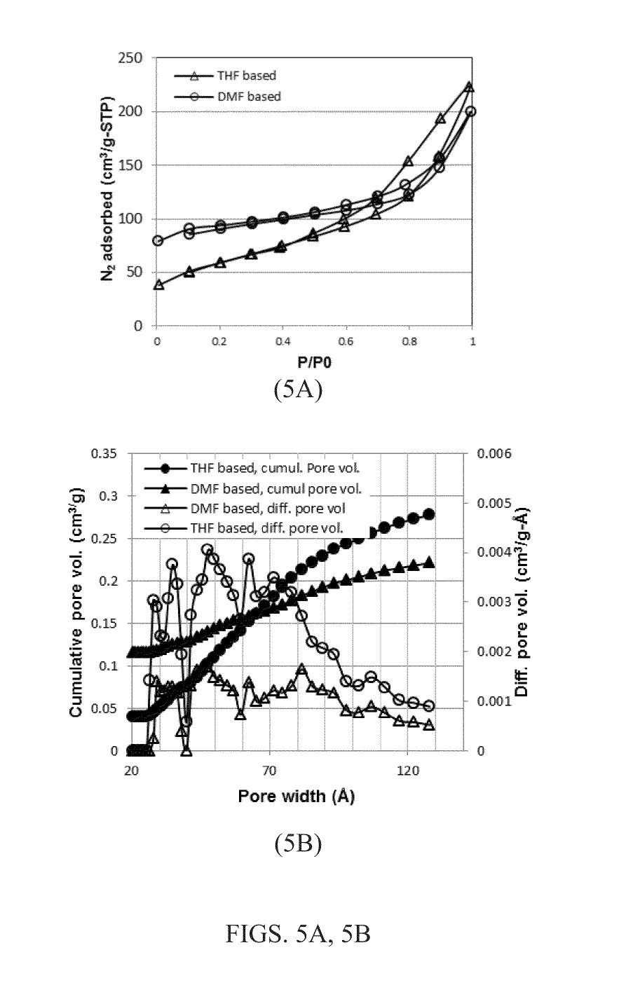

Acid-digested pre-crosslinked or partially degraded native hardwood lignin (1 g) and the tri-block copolymer Pluronic F127 (1:1 ratio) were dispersed and soaked in 30 cm³ DMF or THF and stirred for about 24 hours at ambient temperature. Then the solution was placed on a Petri dish and dried in the same manner as in Example 3 (for DMF), and at 30° C. for one day for THF. The dried mass was carbonized and analyzed in the same manner as described in Example 3. FIG. 5A shows an adsorption-desorption plot of the resulting mesoporous carbon for each of the DMF and THF solvents. FIG. 5B shows pore size distribution plots (both cumulative and differential pore volumes) of the resulting mesoporous carbons for each of the DMF (LMC-5) and THF (LMC-6) solvents. The accessible mesopore widths of LMC-5 and LMC-6 are within 25 to 120 Å.

### Example 8

### Analysis and Characterization of Crosslinked Precursors and Resulting Mesoporous Carbon

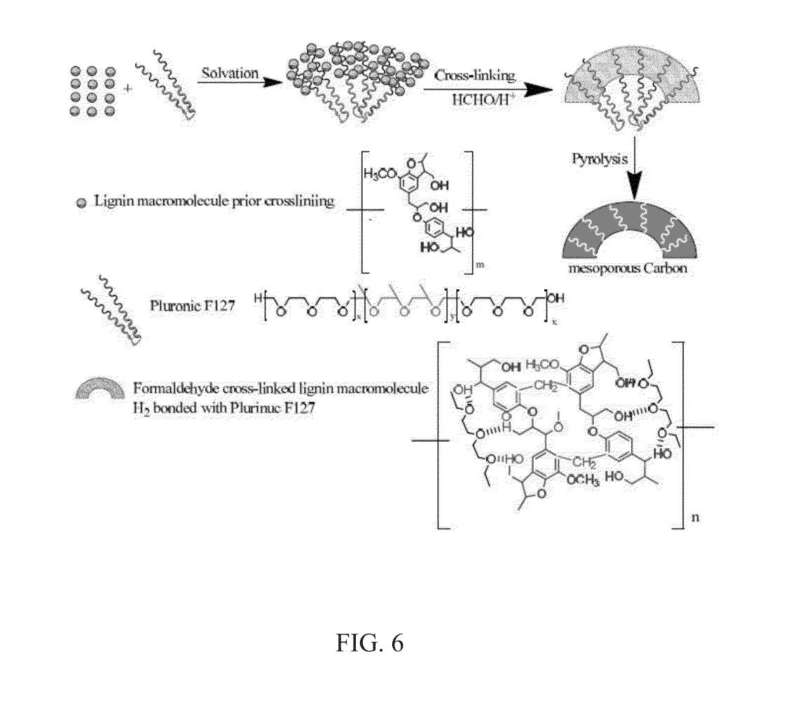

The lignin employed in this study was the methanol soluble fraction of an experimental Kraft-processed hardwood lignin. It is presumed that fractionation with the help of methanol isolates the lower molecular weight fraction of lignin that provides better control over the mesoporosity of the resultant carbon. In this work, Pluronic F127 (BASF) was employed as a templating surfactant. This type of surfactant can be described by the molecular formula [(PEO)ₓ(PPO)_{y}(PEO)ₓ] (x=106, y=70) with an average molecular weight of 12,600. In accordance with past studies (e.g., Linag. C.; Dai, S.; J. Am. Chem. Soc., 2006, 128, 5316-5317), it is believed that the incorporation of the triblock copolymer induces a hydrogen bond between PEO units of the copolymer and hydroxyl groups of lignin in the periphery of micelles, whereas PPO units of the copolymer are expected to occupy the central position of a micellar domain. FIG. 6 graphically depicts the manner in which the surfactant may work to organize the lignin macromolecules. At least by one embodiment, the optimal concentration of surfactant-to-lignin (by mass) found was 1.05:1, for which the resulting carbon material is designated as LMC-1 (lignin derived mesoporous carbon-1). The polymer precursor, before carbonization, is herein designated as poly-LMC-1. In order to have an understanding on the concentration of surfactant on the templating effect, two compositions were also examined with a surfactant-to-lignin ratio of 2.1:1 (LMC-2), as well as a control with zero surfactant concentration (LC-0).

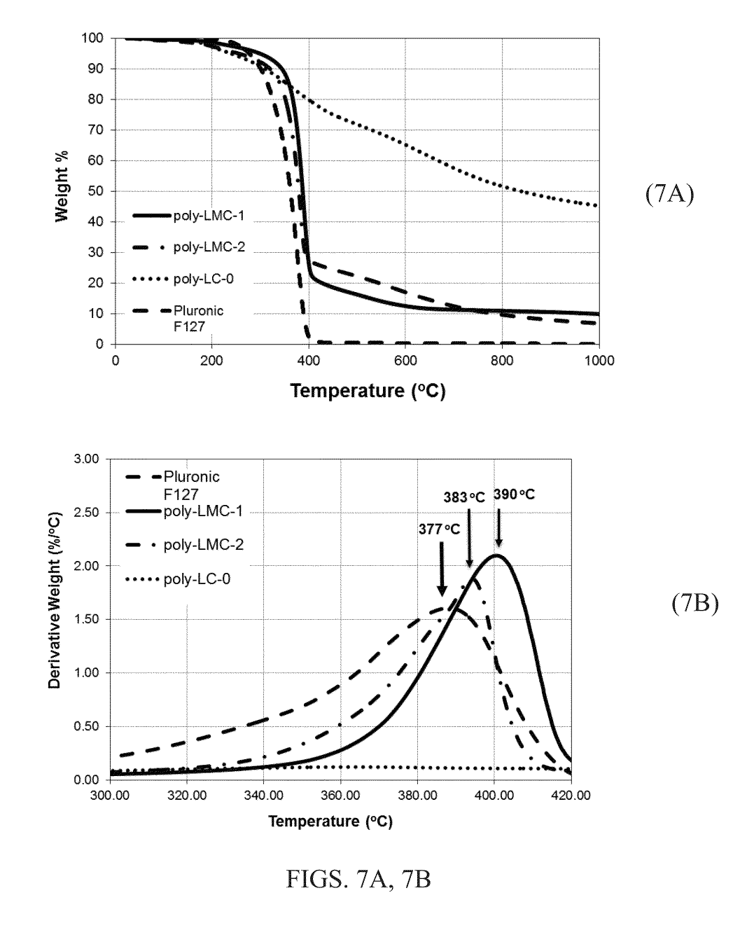

Prior to carbonization, the pristine polymer samples were examined by thermogravimetric analysis, for which the results are shown in FIG. 7A. As shown, both poly-LMC-2 and poly-LMC-1 samples began to lose weight at and above 200° C., which is attributed to the decomposition of Pluronic F127. Both samples provided a carbon residue within 10%, which resulted in an effective carbon yield of 20-22% based on lignin content. The effective carbon yield is significantly lower than the pure lignin-formaldehyde crosslinked sample (˜45%) without the surfactants. The foregoing result can be primarily caused by the presence of excess surfactant molecules that can potentially wrap a significant portion of lignin macromolecules that are not available for crosslinking. As observed in the derivative plot of thermogravimetric analysis (FIG. 7B), the initiation of the peak associated with decomposition of Pluronic F127 is shifted towards higher temperature for poly-LMC-2 and poly-LMC-1 compared to pure F127; the decomposition peak shifted to 390° C. and 383° C. for poly-LMC-1 and poly-LMC-2, respectively, from 377° C. The elevation in decomposition peak strongly implicates the presence of a significant lignin-surfactant interaction as a key mechanism in self-assembly. The elevation in thermal decomposition temperature for poly-LMC-1 provides an indication of better self-assembly of lignin and surfactant with resulting superior porosity. The following sections of this example further illustrate these initial findings.

The pore textural properties of the mesoporous carbons were investigated by nitrogen adsorption-desorption analysis performed at 77 K and pressure up to ambient conditions. The adsorption-desorption isotherms, as shown in FIG. 1A, are of Type IV according to the IUPAC nomenclature. BET specific surface areas calculated from adsorption plots are 418 and 205 m²/g for LMC-1 and LMC-2, respectively. The cumulative pore size distribution plot, as shown in FIG. 1B, was calculated by non-local density functional theory (NLDFT) and shows that the mesopore volume was as high as 0.34 cm³/g for LMC-1, which leads to a mesopore volume over two times greater than the micropore volume. The pore textural characteristics of various other lignin-derived mesoporous carbons are provided in more detail in Table 2 below.

TABLE 2
Pore textural characteristics of various lignin-derived
mesoporous carbons

| Sample | Sample identity; | BET SSA | Mesopore | Total pore |
|---|---|---|---|---|
| name | (F127 content %) | (m²/g) | vol. (cm³/g) | vol. (cm³/g) |
| LMC-1 | HCHO/acid; (105) | 418 | 0.34 | 0.50 |
| LMC-2 | HCHO/acid; (210) | 205 | 0.13 | 0.20 |
| LMC-3 | HCHO/base; (160) | 222 | 0.15 | 0.22 |
| LMC-4 | HMTA/base; (160) | 214 | 0.17 | 0.19 |
| LMC-5 | Pre-crosslinked | 208 | 0.24 | 0.28 |
| | lignin/THF (116) | | | |
| LMC-6 | Pre-crosslinked | 276 | 0.11 | 0.22 |
| | lignin/DMF (116) | | | |

The differential pore size distribution, as also shown in FIG. 1B, indicates that the mesopore volume occupies the pore widths within the range of 20-40 Å to 100-120 Å. The wider distribution of mesopore widths can be attributed to the heterogeneity and unequal lengths of lignin polymeric macromolecules, which leads to a lessening of uniform and consistent structure during the course of self-assembly. Significantly, the carbon obtained from lignin-formaldehyde crosslinked polymer without the presence of surfactant exhibited extremely poor porous structure with an order of magnitude lower pore textural characteristic (BET specific surface area of 36 m²/g and total pore volume 0.036 cm³/g). The foregoing result clearly demonstrates the effective role of surfactant in producing the porous moieties within the carbon matrix.

The better pore textural properties of LMC-1 suggests that surfactant concentration plays a significant role in converting the porous identities from the pristine polymer. At above 100% surfactant ratio over the pure lignin, the surfactant behaves as a continuous phase with surfactant-swollen crosslinked lignin as droplets or domains in the soft matrix, which collapses during thermal pyrolysis. Thus, it has been found herein to be very difficult to obtain high porosity from such a composition where lignin molecules fail to create a continuous matrix.

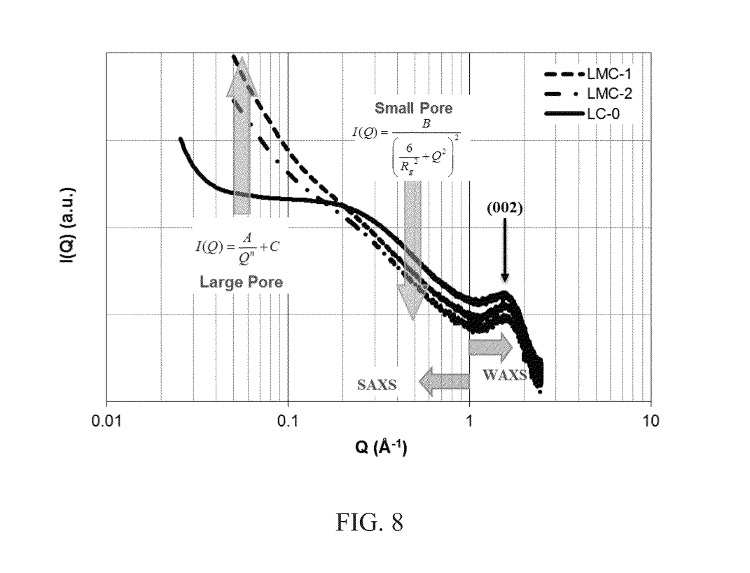

In order to better elucidate the structures and porous moieties of the produced mesoporous carbons, the mesoporous carbons were studied with small-angle and wide angle X-ray scattering (SAXS and WAXS) methods operated with CuKα emission (λ=1.54 Å). FIG. 8 shows small-angle X-ray scattering (SAXS) and wide-angle X-ray scattering (WAXS) results for LMC-1 and LMC-2 carbon compositions. The absence of a peak in the SAXS pattern does not support the possibility of any long range order in these materials. The patterns can be studied for porosity on the basis of two phase (carbon matrix and pore) approximation. In the SAXS/WAXS pattern, the broad (002) peak due to the disordered graphitic layers is prominent in all the patterns. A small hump within the Q values of 0.1-0.2 to 0.5-0.8 Å-1 can be observed in each of the patterns, but their intensities decrease from LC-0 to LMC-1 to LMC-2. Such a hump can be attributed to the micro/mesoporosity (smaller pores) of carbon based material, whereas the smoother pattern in the high Q region representative of larger (meso/macro) porosity. In order to obtain quantitative porosity characteristics, the SAXS pattern has been modeled with an equation (as described in Kalliat et al., American Chemical Society: Washington D.C., 1981; vol 169, pp 3-22), reproduced as follows:

$$I ( Q ) = \frac{A}{{Q}^{n}} + \frac{B}{{( \frac{6}{{R}_{g}^{2}} + {Q}^{2} )}^{2}} + C$$

In the above equation, Q=scattering vector, I(Q)=scattering intensity, R_{g}=radius of gyration, A=contributions from large (macropores), B=contributions from small (micropore) and C=background. The scattering patterns of LMC-1 and LMC-2 are shown in FIG. 8. It was observed that the value of A decreases from LMC-1 to LC-0, which suggests the lowering of larger porosity and supports the adsorption analysis. Although the value of B (smaller porosity) decreased from LMC-1 to LMC-2 supporting the adsorption analysis, there was a sharp increase in value of A for LC-0 that completely contradicts the adsorption measurements and suggests the possible generation of a significant amount of closed microporosity within LC-0 that became invisible to the gas adsorption studies.

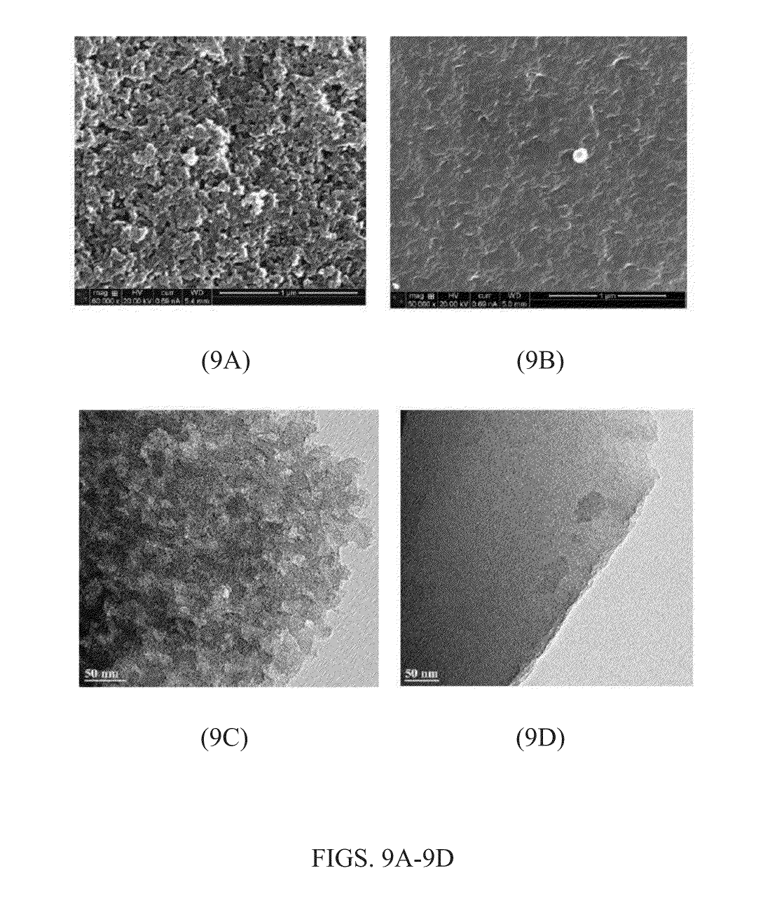

The effects of surfactant addition on the texture of carbon are clearly visible in scanning electron microscopic (SEM) images of the lignin-derived carbons, as provided in FIGS. 9A and 9B. The SEM images are consistent with the presence of macroscopic wrinkles on the surface of LMC-1 caused by micelle formation within the precursor. It is plausible that a large volume of macropores originate within these macrostructures, with micro/mesopores situated within the microscopic domains of these structures, although not visible within the current magnification of the image. Nevertheless, the surface of LC-0 appears to be quite smooth and glassy, which suggests the absence of open pores in the macroscopic domains. Transmission electron microscopy (TEM) images, as shown in FIGS. 9C and 9D, confirm the presence of porosity in LMC-1 in the microscopic domains, although the structural order of the pores were not visible in this carbon. The foregoing is likely attributed to the heterogeneity and hyperbranched segments of lignin macromolecules, as well as weak micelle organization in solvent of lower polarity, such as THF, compared to aqueous medium. The microscopic domains of LC-0 appear to be relatively smooth and do not reflect any substantial porosity compared to its surfactant induced neighbour, confirming the evidence provided by its SEM image.

The key advantages of incorporating a mesoporous material as a drug release medium are two phase. First, by virtue of its high specific area, the mesoporous carbon can confine the poorly soluble drug within its porous moiety on a molecular level, thereby negating its crystallization energy. Second, the mesoporous carbon can exert superior control in the release of the drug by desorption and diffusion from its pores for a sustained period of time. This process can provide a zero premature release and eliminates the possibility of an ineffective saw tooth profile of drug concentration or toxic level of prolonged heavy drug exposure.

In this work, LMC-1, LMC-2 and PMC (phloroglucinol derived mesoporous carbon) were incorporated as a release medium for (i) captopril, which is used as an angiotension-converting enzyme (ACE) inhibitor drug and prescribed for the treatment of hypertension and certain classes of congestive heart failure, (ii) furosemide, which is a loop diuretic drug, used to treat congestive heart failure and edema, (iii) ranitidine, which is a histamine hydrogen-receptor antagonist that inhibits stomach acid production, and (iv) antipyrine, which is an analgesic or antipyretic drug. Specifically, 40 mg of mesoporous carbon was loaded with specific drugs by mixing it with an excess aqueous solution (in the case of captopril, ranitidine and antipyrine) or alcoholic solution (in the case of furosemide) (e.g., 40 mg in 3 cm³) for two hours under mild stirring conditions (˜60 rpm). The loaded mesoporous carbons were dried, the external surface cleaned, and then placed into 130 cm³ of simulated gastric fluid without pepsin (SGF; 0.2% w/v NaCl, aqueous HCl, pH adjusted to ˜1.5) or into simulated intestinal fluid (SIF) at ambient temperature for 30-50 hours under mild stirring (˜60 rpm) for in-vitro drug release. The drug concentrations were measured by UV-Vis spectroscopy utilizing a calibration curve on absorbance at various concentrations of the drug in SGF or SIF medium.

The drug loading amount in PMC and LMC-2 were measured with the help of thermogravimetric analysis (TGA). Pure mesoporous carbons, pure drugs, and drug-loaded carbons were heated under an inert atmosphere (N₂) up to 1000° C., wherein the drug loading amount was calculated by comparing the relative amount of residues. Table 3 shows the captopril, furosemide, ranitidine and antipyrine loading in PMC and LMC-2.

TABLE 3
Drug loading amounts in PMC and LMC-2 mesoporous carbons

| Drugs | Loading percent in PMC | Loading percent in LMC-2 |
|---|---|---|
| Captopril | 13 | 5 |
| Furosemide | 6.7 | 6.6 |
| Ranitidine | 11 | 4 |
| Antipyrine | 22 | 12 |

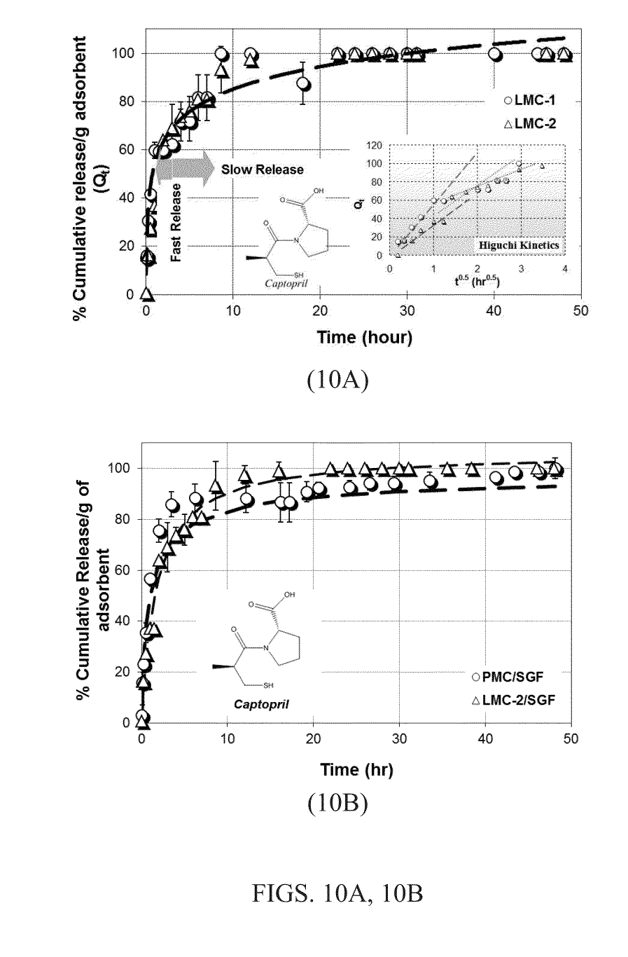

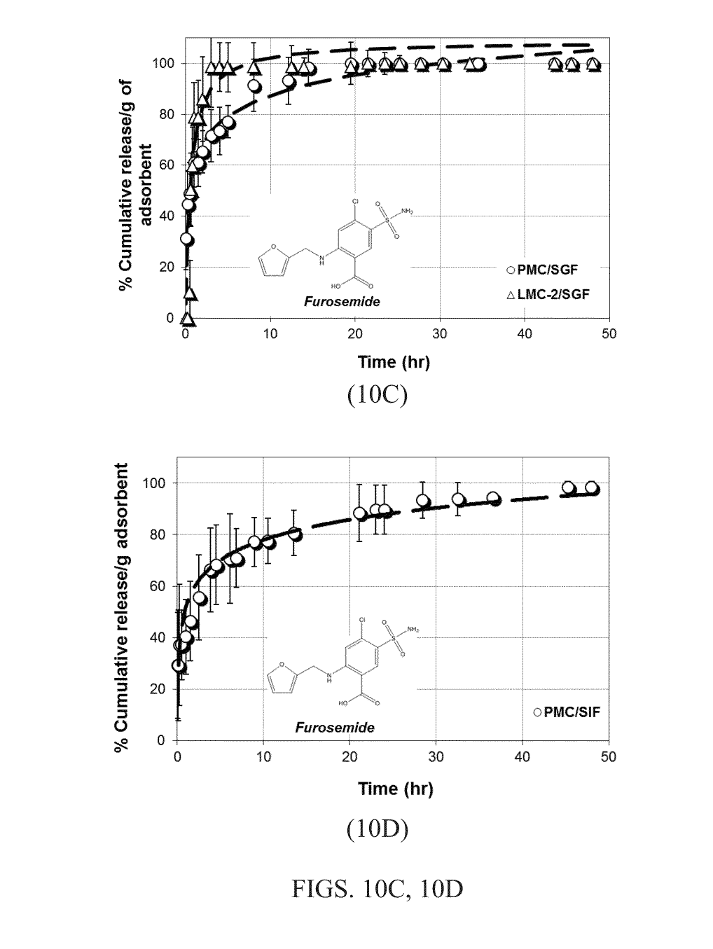

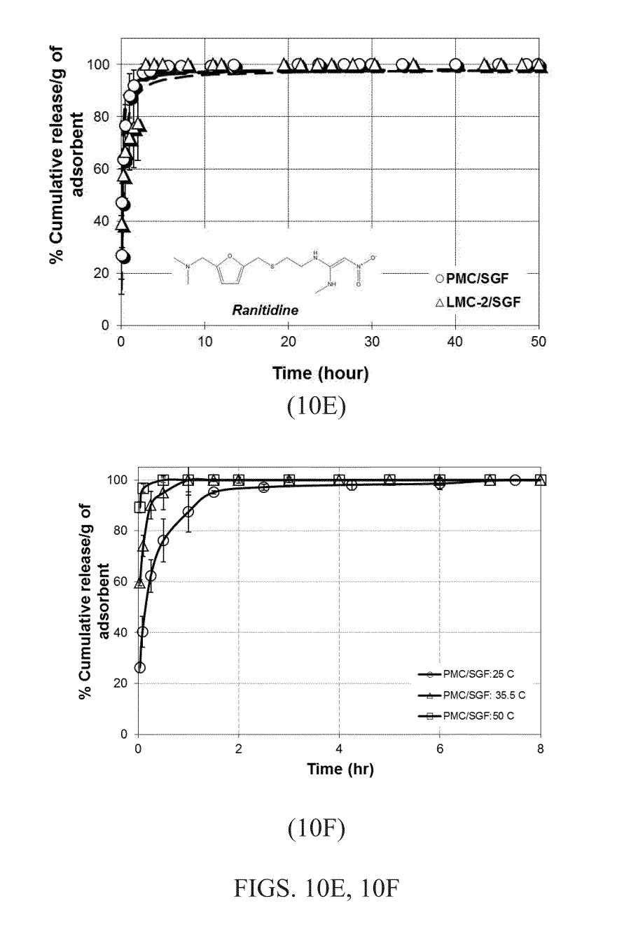

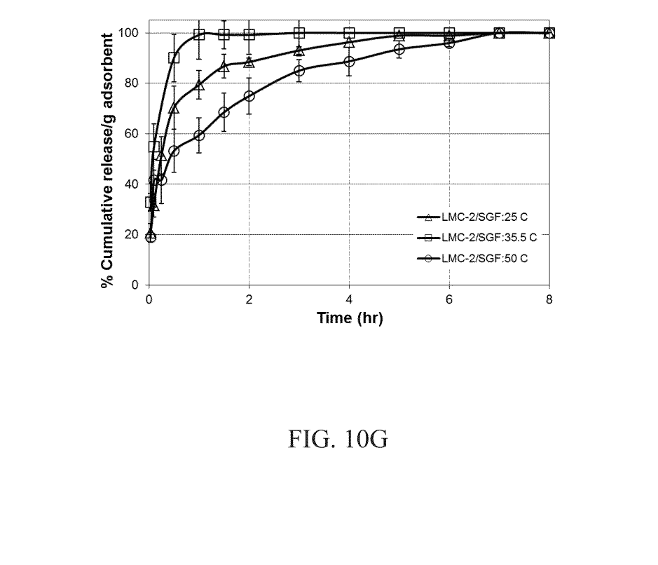

FIG. 10A shows the captopril release profile under an examination time of 30 hours. The pattern suggests that LMC-1 could well control the release of the drug in a prolonged interval of time. It is observed that 60-70% of the drug was released rapidly within four hours of exposure time, after which the release profile attains a level plateau, which suggests a slowing in release amount in the later period of time. Higuchi kinetic analysis (T. Highuchi, J. Pharma Sci., 1961, 50, 874-875; T. Highuchi, J. Pharma Sci., 1963, 52, 1145-1149) within the inset of FIG. 10 also confirmed two different regimes of drug release, which results in two possible release constants values, although the linear region in the longer time interval significantly deviates from a line passing through the origin. Kinetic analysis by the Korsmeyer-Peppas equation (R. W. Korsmeyer, et al., Intl. J. Pharm., 1983, 15, 25-35) within around 60% of total drug release provides the release rate constant value and order of release of 3.9 and 0.42 respectively, suggesting dominance of Fickian diffusion in the release kinetics.

FIG. 10B shows captopril release profiles from LMC-2 and PMC. For captopril, first burst release exposes almost 50% of the drug within 1-2 hours, after which the release pattern attains a steady state of release. PMC was able to release captopril continuously up to almost 40 hours, whereas LMC released almost all the drugs before 20 hours. The fast release by LMC can be attributed to its much wider pore width compared to PMC. Assuming physisorption is the key responsible phenomena to hold the drug molecules within the porous entity of the carbons, the London dispersion force field increases with the decrease in square of the pore width, thus resulting in a higher adsorption potential and sluggish desorption in the narrower pores of PMC. Indeed, captopril release from PMC demonstrated slower release kinetics compared to that of captopril-loaded SBA-15 and MCM-41 in simulated stomach acid, as described in Qu et al., ChemPhysPhem 7 (2006) 400-406). However, the release pattern by PMC is faster compared to that of release in simulated intestinal fluid by MCM-41, which may be related to the higher pH of simulated intestinal fluid.

FIGS. 10C and 10D show release profiles of furosemide in SGF and SIF, respectively. The release of furosemide from PMC is slower than LMC in SGF as the release medium. The initial burst was observed for 60% of drug within 1.5 hours. It took 30-40 hours to complete the release of furosemide from PMC, whereas LMC released all the adsorbed furosemide in less than 10 hours. The faster desorption from LMC, again, can be related to its wider pore width, which could not exert enough adsorption potential to hold a larger furosemide molecule. Obviously, as lignin has more structural heterogeneity, it cannot generate as controlled a porosity as can be provided by phloroglucinol. As furosemide is acidic in nature, its release from PMC in simulated intestinal fluid (SIF), which possesses a higher pH value (˜6.8), was also investigated. In SIF, furosemide was completely released in 30-40 hours, which is very similar to that found for SGF. Such a pattern of release is, indeed, quite slower compared to that exhibited by mesoporous silica nanoparticles in the pH range of 5.5 to 7.4 (release completed in less than 100 minutes), as reported by Salonen et al., J. Controlled Release, 1008 (2005) 362-374. The foregoing result suggests that mesoporous carbon could serve as a better choice over mesoporous silica particles for better controlled release. Similar release patterns of furosemide in SGF and SIF suggests that the diffusion barrier for dissolving from the pores is the key controlling factor over pH of the release media.

FIG. 10E shows the release profiles of ranitidine from LMC-2 and PMC in SGF. The release of ranitidine by PMC and LMC is much faster compared to captopril. It is observed that almost all ranitidine molecules are released in less than 10 hours with a negligible difference in release rates between PMC and LMC. The release of ranitidine was also observed to be completed within 100 minutes or less than 2 hours from mesoporous silica particles in the report of Salonen et al (Ibid.). The faster release of ranitidine can, very likely, be related to its larger molecular size. It can be hypothesized that the larger ranitidine molecule can no longer penetrate the inner pores, and thus, mostly rests near the pore mouth region or very large pores in a loosely adsorbed state. Staying outside the main influence of a strong adsorption barrier, it needed to overcome only a small diffusion resistance and hence could be desorbed very quickly.

FIGS. 10F and 10G show the release profiles of antipyrine from PMC and LMC-2, respectively, in SGF. Each of the release patterns were investigated at the following three temperatures: 25° C., 35.5° C. and 50° C. As expected, the release patterns displayed faster kinetics with an increase in temperature. For PMC, it took about 2-3 hours to completely release the antipyrine at 25° C., whereas it released all of the drugs within 30 minutes when the temperature of the release medium was increased to 50° C. The release kinetics of antipyrine from LMC appear to demonstrate much slower kinetics. At 25° C., almost 7 hours were required to release all antipyrine; the release time was lowered to about an hour when the temperature was increased to 50° C. The completion of release of antipyrine from PMC was within the same range of that from porous silica (300 min.) as reported by Salonen et al. (Ibid.)

The presence of fast and slow regimes in the drug release profiles is quite ubiquitous in porous media based drug delivery systems (J. Anderson, et al., Chem Mate., 2004, 16, 4160-4167; F. Qu, et al., ChemPhysChem, 2006, 7, 400-406). For mesoporous silica, these two regimes were explained by partial solubility of silica in dissolution media and the pore size effect (Anderson et al., Ibid.). As dissolution of media can be ruled out for carbon-based porous systems, the only controlling influence is a pore geometry effect that influences the Fickian diffusion (for slow stirring, the turbulence effect can be neglected). It can be hypothesized that the drug molecules present near the pore mouth experience the least sorption potential and a shorter path of diffusion resistance, and therefore, can be released in the fastest interval of time. Drugs located deep inside the pore experience the absorption-desorption equilibrium before reaching the pore mouth, and thus, take longer time to completely desorb. As a majority of carbon-based materials possess varying dimensions of pore widths, a wider pore would provide a weak adsorptive potential compared to a narrower pore, and hence, allow the drug to escape early. It can also be hypothesized that a similar sized tortuous pore will present more resistance in the path of diffusion compared to a straight pore, which would make dissolution of the drug difficult.

In order to further investigate the diffusivity of the loaded drugs in the releasing media, Fick's laws of diffusion in spherical and cylindrical coordinates were utilized. Based on the assumption that drug-loaded mesoporous carbons are monolithic systems, the release profile in the spherical system can be mathematically expressed as (J. Siepmann, F. Siepmann, J., Controlled Release, 161 (2012) 351-362.):

$$\frac{{M}_{t}}{{M}_{α}} = 1 - \frac{6}{{π}^{2}} {\sum }_{m = 1}^{α} \frac{exp [ - {Dn}^{2} {π}^{2} t \text{/} {R}^{2}}{{n}^{2}} \qquad ( 1 )$$

In the above equation, Mₜ and M_{α} are the released amounts at time t and infinite time, and R is a spherical radius and D is diffusivity.

$$At \frac{{M}_{t}}{{M}_{α}} > 0.6 ,$$

equation (1) can be approximated as:

$$\frac{{M}_{t}}{{M}_{α}} = 1 - \frac{6}{{π}^{2}} exp ( - \frac{{π}^{2} Dt}{{R}^{2}} ) . \qquad ( 2 )$$

For a cylindrical system, the exact solution can be expressed as:

$$\frac{{M}_{t}}{{M}_{α}} = 1 - \frac{32}{{π}^{2}} {\sum }_{n = 1}^{α} \frac{1}{{q}_{n}^{2}} exp ( - \frac{{q}_{n}^{2}}{{R}^{2}} Dt ) \cdot {\sum }_{p = 0}^{α} \frac{1}{{( 2 p + 1 )}^{2}} \cdot exp ( - \frac{{( 2 p + 1 )}^{2} {π}^{2}}{{H}^{2}} Dt ) \qquad ( 3 )$$

In the above equation, R and H are the radius and length of cylinder respectively. Similar to the previous condition,

$$\frac{{M}_{t}}{{M}_{α}} > 0.6 ,$$

the solution can be approximated as:

$$\frac{{M}_{t}}{{M}_{α}} = 1 - \frac{4}{{2.405}^{2}} exp ( - \frac{{2.405}^{2} Dt}{{R}^{2}} ) \qquad ( 4 )$$

It has been shown that a linear regression of ln

$$( 1 - \frac{{M}_{t}}{{M}_{α}} )$$

versus t will yield the diffusivity values for both types of systems. It is quite unlikely, in line with the TEM images, that the pores present in the mesoporous carbon systems described herein possess a single unvarying geometrical shape. However, a closer inspection indicates that the pore geometries have a spherical-to-cylindrical shape, which would be in agreement with the soft-templating methodology shown in FIG. 6. As the centers of micelles are believed to give rise to the mesopores, and because the micelles are approximately spherical in shape, a distorted spherical to cylindrical entity could serve as the closest approximation of the pore geometry. Based on these assumptions, diffusivity values have been calculated from all the release patterns for both spherical and cylindrical systems. The foregoing results are shown in Table 4, provided below.

TABLE 4
Diffusivity values of drug release from PMC and LMC-2

| | Diffusivity (m²/s) | | | | | |
|---|---|---|---|---|---|---|
| | PMC/SGF | | LMC/SGF | | PMC/SIF | |
| Drugs | Spherical | Cylindrical | Spherical | Cylindrical | Spherical | Cylindrical |
| Captopril | 7 × 10⁻²⁴ | 2 × 10⁻²³ | 9 × 10⁻²³ | 2 × 10⁻²² | — | — |
| Furosemide | 4 × 10⁻²³ | 7 × 10⁻²³ | 4 × 10⁻²² | 6 × 10⁻²² | 1 × 10⁻²³ | 2 × 10⁻²³ |
| Ranitidine | 1 × 10⁻²² | 2 × 10⁻²² | 1 × 10⁻²² | 2 × 10⁻²² | — | — |

From Table 4, it is clear that the diffusivity lies within the order of 10⁻²² to 10⁻²⁴ m²/s, which is quite typical for solid diffusion. Except captopril, the order of the magnitude of diffusivity did not change from a spherical to cylindrical system. For furosemide, the diffusivity is within the order of magnitude of 10⁻²³ m²/s for its release from PMC in both SGF and SIF. It supports the similar release patterns in both types of simulated fluids as discussed previously. Thus, the diffusivity of furosemide is one order of magnitude higher for LMC (10⁻²² m²/s), which is also consistent with furosemide's faster release from LMC. For ranitidine, the diffusivity is on the order 10⁻²² m²/s for both types of carbons. Although the higher diffusivity of captopril release from LMC compared to PMC can be attributed to the faster release owing to large pore widths of LMC, it is quite challenging to hypothesize the reason for the altering in the order of magnitude of diffusivity values from spherical to cylindrical systems, unlike for the two other drugs. One possible reason can be related to the smaller molecular size of captopril compared to the two other drugs, which may make its diffusive motion more sensitive to the pore geometry.

A linear regression is made within the plots of ln

$$( 1 - \frac{{M}_{t}}{{M}_{α}} )$$

versus t which also yields the diffusivity values of antipyrine from LMC-2 and PMC at three temperatures of 25° C., 35.5° C., and 50° C. Because of the surfactant templating, it was assumed that the mesopore geometries have a spherical to cylindrical shape, which became a basis for calculating the diffusivity values from each of the patterns in both cylindrical and spherical systems. Table 5, below, provides diffusivity values for spherical and cylindrical pores in LMC-2 and PMC mesoporous carbons.

TABLE 5
Diffusivity values of antipyrine release from PMC and LMC-2

| Type of | T | Diffusivity | Diffusivity |
|---|---|---|---|
| Carbon | (° C.) | (Spherical), m²/s | (Cylindrical), m²/s |
| PMC | 25 | 1.4 × 10⁻²² | 2.3 × 10⁻²² |
| | 35.5 | 8.2 × 10⁻²² | 1.4 × 10⁻²¹ |
| | 50 | 3.4 × 10⁻²¹ | 5.8 × 10⁻²¹ |
| LMC-2 | 25 | 4.1 × 10⁻²³ | 7.0 × 10⁻²³ |
| | 35.5 | 1.4 × 10⁻²² | 2.3 × 10⁻²² |
| | 50 | 8.9 × 10⁻²² | 1.5 × 10⁻²¹ |

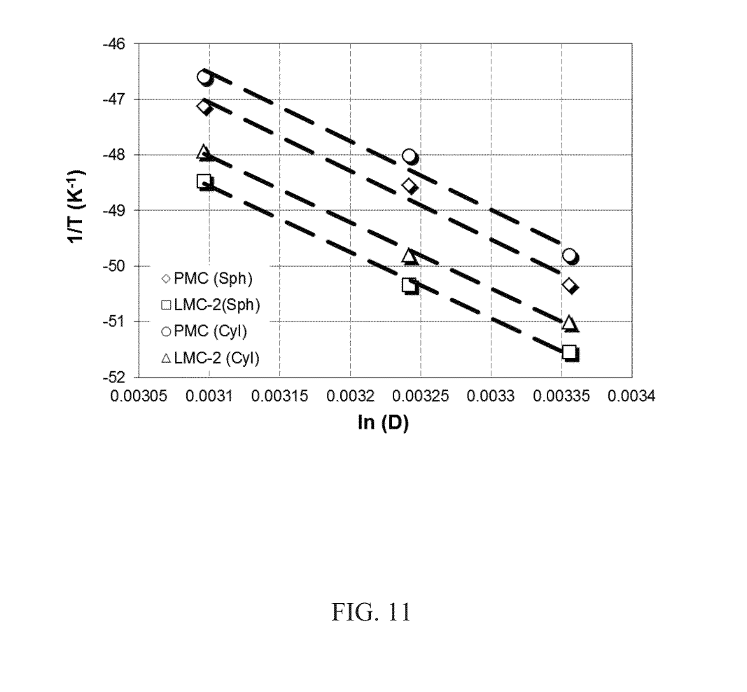

As shown by Table 5, all of the diffusivity values are within an order of magnitude of 10⁻²¹ to 10⁻²³ m²/s, and increased to one to two orders of magnitude with an increase in temperature from 25° C. to 50° C. In order to provide further insight on the temperature dependence of diffusivity, calculations were made using the Eyring equation by assuming antipyrine diffusion from the pores of the carbons is an activation process,

$$D = {D}_{o} exp ( - \frac{{E}_{a}}{RT} ) , \qquad ( 5 )$$

where E_{α} is the activation energy. A linear regression of ln D versus 1/T is shown in FIG. 11 and yields the activation energy values. Very good linearity was observed as the R² values ranged from 0.98 to 0.99. Activation energy values were calculated to be 102 and 98 kJ/mol for PMC and LMC, respectively, and they did not depend on the spherical or cylindrical systems. A slightly higher value of activation energy of PMC likely suggests that the diffusion of antipyrine from its pore is more temperature dependent than that from LMC, which may be attributed to the narrower pore width in PMC.

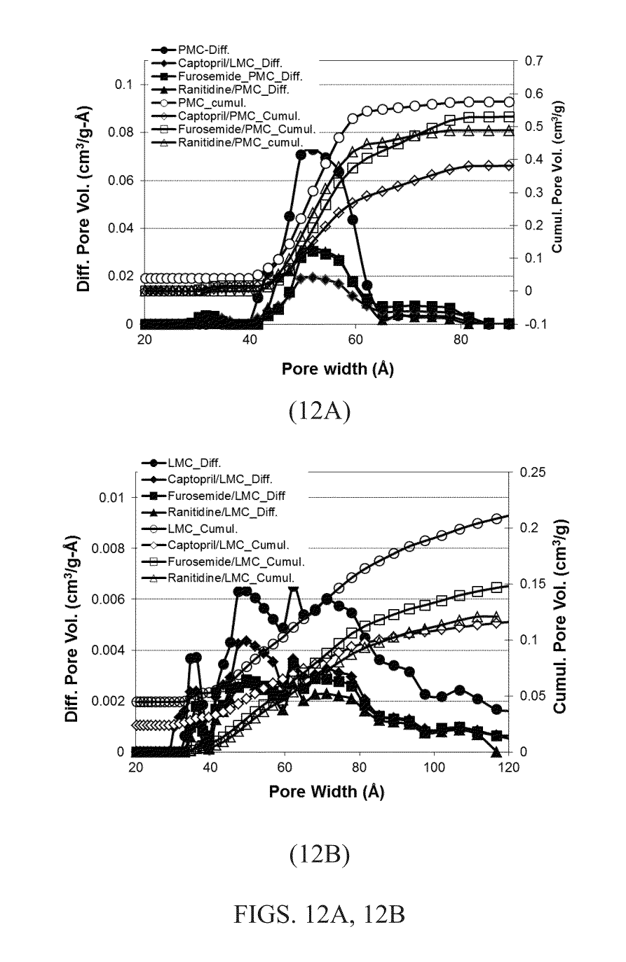

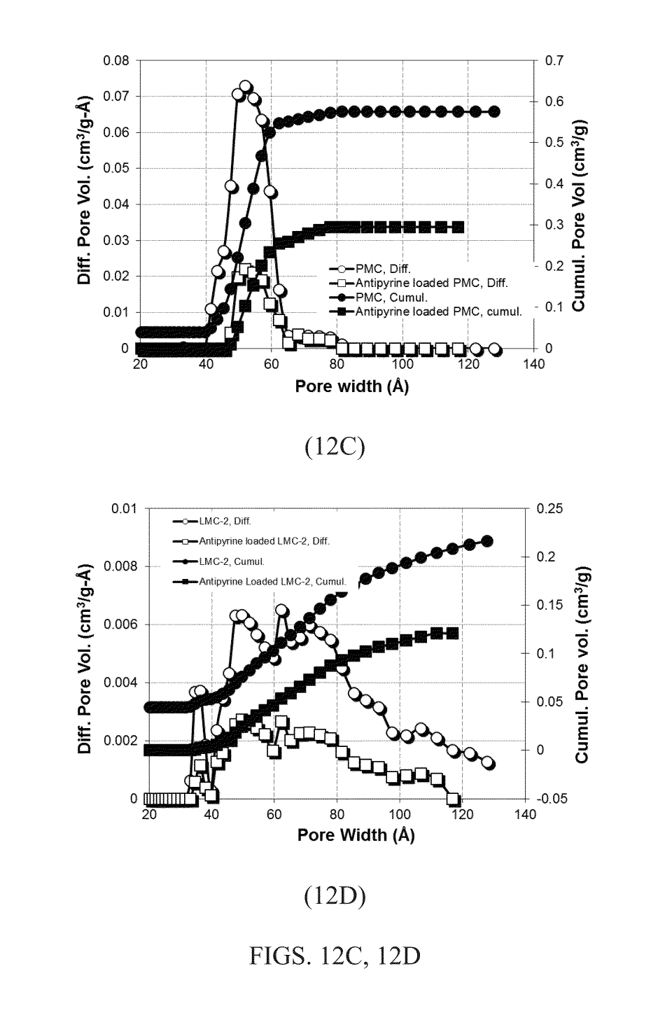

In order to further investigate the occupancy of pore space by drug molecules, N₂ adsorption-desorption experiments were performed on the drug-loaded mesoporous carbons, and the pore size distribution was calculated by the NLDFT method. The pore size distributions of captopril-, furosemide-, and antipyrine-loaded PMC and LMC-2, and their unloaded carbon counterparts, are shown in FIGS. 12A-12B. As shown, the pore volumes of two of the carbons were diminished significantly upon drug loading due to the partial occupancy of pores by drug molecules. The most common observation is the minimum pore filling by furosemide for both types of carbons, which can be related to furosemide's poorer loading and larger molecular architecture along with its two aromatic rings that likely give rise to instability within the porous moiety. For PMC, the highest pore filling is provided by captopril, followed by ranitidine. The foregoing results are in agreement with the calculated drug loading amount. Most likely, the smaller size of captopril compared to ranitidine aided in its adsorption in larger amounts. For LMC-2, the pore filling by captopril and ranitidine is similar, which can be attributed to the less available pore space and much wider pore widths. The pore size distributions of antipyrine-loaded PMC and LMC-2 are shown in FIGS. 12C and 12D. In similar fashion to the other drug-loaded mesoporous carbons, the pore volume is lowered most likely as a result of partial occupancy by antipyrine molecules.

In conclusion, a surfactant templated mesoporous carbon has been synthesized from a sustainable precursor, lignin. Earlier reports of lignin-based activated carbon indicate a predominance of microporosity. Without being bound by any theory, it is believed that self-assembly provided by hydrogen bonding between hydroxyl groups in the lignin macromolecules and oxygen atoms of PEO domains within the tri-block co-polymers is the key mechanism by which mesoporosity arises. Such lignin-derived mesoporous carbon possesses a moderate BET surface area of 418 m²/g and mesopore volume (0.34 cm³/g) that is twice the micropore volume. Small-angle X-ray scattering and electron microscopic images confirmed the role of surfactant in inducing the porosity in the lignin-derived mesoporous carbons. This mesoporous carbon has successfully maintained the controlled release of an ACE-inhibitor drug, Captopril, which demonstrates the utility of the mesoporous carbon as a controlled drug delivery medium. Moreover, the successful utilization of lignin to produce the mesoporous carbon would beneficially contribute to the environment and economy by relying on an inexpensive and natural precursor.

While there have been shown and described what are at present considered the preferred embodiments of the invention, those skilled in the art may make various changes and modifications which remain within the scope of the invention defined by the appended claims.

1. A composition comprising: (i) a mesoporous carbon structure containing mesopores having a distribution of pore diameters within a range of 2 to 50 nm, wherein said distribution of pore diameters has a maximum mesopore size that is at least 10 nm greater than a minimum mesopore size, and (ii) at least one pharmaceutical compound adsorbed in said mesopores.

2. The composition of claim 1, wherein said mesopores have a maximum mesopore size of 20 nm.

3. The composition of claim 1, wherein said mesopores have a maximum mesopore size of 15 nm.

4.-5. (canceled)

6. The composition of claim 1, wherein said mesoporous carbon structure possesses a surface area of at least 200 m²/g.

7. The composition of claim 1, wherein said mesoporous carbon structure possesses a surface area of at least 300 m²/g.

8. The composition of claim 1, wherein said mesoporous carbon structure possesses a surface area of at least 400 m²/g.

9. The composition of claim 1, wherein said mesoporous carbon structure possesses a total pore volume of at least 0.2 cm³/g.

10. (canceled)

11. The composition of claim 1, wherein said at least one pharmaceutical compound comprises at least two pharmaceutical compounds.

12. A method of fabricating a porous carbon composition, the method comprising subjecting a precursor composition to a thermal annealing step followed by a carbonization step, the precursor composition comprising: (i) a templating component comprised of a block copolymer and (ii) a lignin component, wherein said carbonization step comprises heating the precursor composition at a carbonizing temperature for sufficient time to convert the precursor composition to a carbon material comprising a carbon structure in which is included mesopores having a diameter within a range of 2 to 50 nm, wherein said porous carbon composition possesses a mesopore volume of at least 50% with respect to a total of mesopore and micropore volumes.

13. The method of claim 12, wherein said block copolymer comprises a poloxamer triblock copolymer.

14. The method of claim 12, wherein said templating component and lignin component are in a ratio within a range of 2:1 to 1:2.

15. The method of claim 12, wherein said templating component and lignin component are in a ratio of about 1:1.

16. The method of claim 12, wherein said mesopores have a maximum diameter of 20 nm.

17. The method of claim 12, wherein said mesopores have a maximum diameter of 12 nm.

18. The method of claim 12, wherein said mesopore volume is at least 60% with respect to the total of mesopore and micropore volumes.

19. The method of claim 12, wherein said mesopore volume is at least 70% with respect to the total of mesopore and micropore volumes.

20. The method of claim 12, wherein said porous carbon structure possesses a surface area of at least 200 m²/g.

21. The method of claim 12, wherein said porous carbon structure possesses a surface area of at least 300 m²/g.

22. The method of claim 12, wherein said porous carbon structure possesses a surface area of at least 400 m²/g.

23. The method of claim 12, wherein said porous carbon structure possesses a total pore volume of at least 0.2 cm³/g.

24. The method of claim 12, wherein said mesopores have a distribution of sizes with maximum and minimum mesopore sizes, wherein said maximum mesopore size is at least 10 nm greater than said minimum mesopore size.

25. The method of claim 12, wherein said precursor composition further comprises (iv) a crosslinkable aldehyde component.

26. The method of claim 25, wherein said crosslinkable aldehyde component comprises formaldehyde.

27. The method of claim 12, wherein said precursor composition further comprises a pH controlling agent.

28. The composition of claim 1, wherein said composition further includes micropores having a diameter of less than 2 nm.
